(19) United States
(12) Patent Application Publication
(10) Pub. No.: US 2018/0040307 A1
(43) Pub. Date: Feb. 8, 2018

(54) STEADY COLOR PRESENTATION MANAGER

(71) Applicant: BARCO N.V., Kortrijk (BE)

(72) Inventors: Matthew MCLIN, Hillsboro, OR (US); Alireza NASIRIAVANAKI, Portland, OR (US); Albert XTHONA, Yamhill, OR (US); Tom KIMPE, Landegem (BE); Johan ROSTANG, Marcq-en-Baroeul (FR); Cedric MARCHESSOUX, Halluin (FR)

(73) Assignee: BARCO N.V., Kortrijk (BE)

(21) Appl. No.: 15/553,109

(22) PCT Filed: Jan. 8, 2016
(86) PCT No.: PCT/EP2016/050313

§ 371 Date: Aug. 23, 2017

Related U.S. Application Data
(63) Continuation of application No. 14/629,557, filed on Feb. 24, 2015.

(51) Int. Cl. G09G 5/393; G09G 5/06; G09G 5/14

(52) U.S. Cl. CPC G09G 5/393; G09G 2380/08; G09G 2360/06; G09G 2340/06; G09G 2320/0693; G09G 5/14; G09G 2320/08; G09G 2320/0666; G09G 2360/145; G09G 2360/12; G09G 5/06; G09G 2340/14

(57) ABSTRACT

A system and method for separately processing content provided by different applications that is rendered on an attached display. The content is processed based upon the desired display settings that are appropriate for the particular application delivering content to a particular region of the display. In this way, simultaneously displayed applications may be processed as intended by each application, independent of differences in the display settings assumed by the displayed applications. The processing can include a calibration method for linearizing the output.

### TECHNICAL FIELD

The present invention relates generally to a display system, and particularly to a method, device, controller, non-volatile (non-transient) memory and system for facilitating or providing display setting management to rendered applications and to software for carrying out any of the methods. In particular the present invention relates to methods, devices, controllers and systems for color processing such as color calibration of displays, to non-volatile (non-transient) memory, controllers, display devices or display systems including at least one transform, e.g. a color calibration transform, to operation of such controllers, display devices or systems and to software for color calibration of a display.

### BACKGROUND

Many software applications assume that their rendered content will be displayed on a display with Standard RGB (sRGB) color space gamut and luminance response. When this assumption fails (e.g., due to a wide gamut display or a display calibrated to the DICOM grayscale display function), the colors and/or luminance of display content rendered on the display for the application may appear incorrect.

Some applications are capable of using ICC profiles for an attached display so that, when rendered, the application appears as expected. However, many existing applications do not support the use of ICC profiles for output devices. Users of these “non-ICC-aware” applications do not have a means of adjusting the rendered content for the application so that it is properly rendered on the display. This problem is compounded by the fact that users may need to work simultaneously with multiple non-ICC-aware applications that each expect a different display behaviour.

Use of ICC profiles by ICC-aware applications can be computationally expensive, in particular for those ICC profiles providing large 3D color lookup tables (CLUTs). In fact, central processing units (CPUs) are often not able to process rendered frames for ICC-aware applications with ICC profiles fast enough to keep up with animated or moving images.

In recent years medical imaging is evolving more and more from pure grayscale images to color images. Until now, color medical imaging has not been standardized, although the situation with colored images case is a bit more complex. Depending on the specific field of medicine, there may be other requirements for the representation of colors. For surgery and examination using for instance endoscopes, an exact representation of colors is a prerequisite. The endoscope combined with the display can be considered as an extension of the doctor's eyes and hence should present an image that is the same as would be provided to the doctor. The same can be held for the interpretation of wound photographs used in tele-medicine, where the color is giving an indication if a wound is healing. The situation is different for the emerging markets of digital pathology or quantitative imaging. For this kind of images it is of great importance, similar to the situation depicted for grayscale images, that the doctor is able to discover relevant medical features in the images. To facilitate the discovery it is important to visualize especially the differences between the features and the background of the image. Hence distinguishability can be more important than a perfectly truthful image.

In a conventional digital image processing chain for pathology, the display is conventionally not considered as an essential part to optimize the detectability of the features in the scanned slides. The approach so far is to represent the colors in exactly the same way as how the pathologist would perceive them when looking through the microscope. To obtain this, the scanned slide is for instance saved in the sRGB color space and the display is assumed to be sRGB calibrated. In the best case ICC profiles can be used to take into account the gamut of the actual display or a specific calibration method is applied to guarantee accurate color reproduction, see for example “WO2013025688 SYSTEM AND APPARATUS FOR THE CALIBRATION AND MANAGEMENT OF COLOR IN MICROSCOPE SLIDES”.

This approach has some flaws. First of all, what is the “correct” color? The colors that are perceived when using a microscope depend on the spectrum of the light source of the microscope. Thus, a slide will look different from microscope to microscope or from set up to set up. In addition, hospitals or laboratories often have their own procedures for preparing slides and to perform the staining. Although more or less the same procedure is used in different labs, the intensity of the staining can vary significantly. To make the situation even more complex, after scanning the slides the colors can differ even more depending on the scanner used. Different scanners with the same illumination can produce images with different colors. Therefore it is not advisable to rely on the exact representation of colors for digital pathology applications.

In quantitative medical imaging, the results of calculations are visualized using pseudo colors on top of other medical images or as images on their own. Because these colors are calculated, it is possible to define a color space in which the image is rendered, for instance sRGB, and by using a display and the correct ICC profiles, the calculated colors can be quite accurately visualized.

However, in such images often there is only a small amount of the scale that is represented by one primary color such as red, whereas another primary color such as green can represent the biggest range of the quantitative values, making it difficult to distinguish the colors in this scale. Using a perceptually linear color scale can help optimize the visualization of the quantitative colors and reveal potentially hidden details in the image. This can only be realized when taking into account the gamut of the display used for the visualization of the image. In both digital pathology and quantitative imaging it is critical to optimally visualize the differences between the features and the background. Therefore, with a similar reasoning one can conclude that digital pathology images may be better interpreted on a perceptually linear color display.

Calibrating a display in such a way that it is perceived as being linear may involve using a perceptually uniform color space. One such color space is proposed in “Toward a Unified Color Space for Perception-Based Image Processing”, Ingmar Lissner and Philipp Urban, IEEE Transactions on Image Processing, (Volume: 21, Issue: 3), 4 Aug. 2011 ISSN:1057-7149. Their “perceptually uniform” and “hue linear” color space is called LAB2000_{HL} (including variations optimized for color difference metrics other than ΔE₂₀₀₀) and is derived from CIELAB and ΔE₂₀₀₀. In this paper reference to “perceptually uniform” means that ΔE₂₀₀₀ within LAB2000_{HL} is a only Euclidean distance locally and it is shown that it is impossible to design a color space in which ΔE₂₀₀₀ is a true Euclidean distance other than locally. The paper discloses iterative adjustment of the color grid points on equi-luminance planes, while enforcing some other constraints including hue-linearity, which causes some loss in perceptual uniformity.

However, when converted to LAB2000HL, sRGB primaries, for examples, end up having largely varying hue values. Another perceptually linear color space contender, UP Lab (http://www.brucelindbloom.com/UPLab.html) does a better job for sRGB blue primary but has problems for green and red. Without being limited by theory, these problems may be due to the fact that both UP Lab and LAB2000_{HL} separate luminance and chrominance at the outset while there is evidence in the literature that the two may not be treated separately in constructing a perceptually uniform color space.

For a color display calibration suited for medical applications, there is a need to find a method of distributing color points across a full display gamut in a perceptually uniform manner while preserving full contrast and color saturation in the calibrated display and without the problems mentioned above with the prior art methods.

### SUMMARY

The present invention aims generally to provide a display system, and particularly a method, device, controller, non-volatile (non-transient) memory or system for facilitating or providing display setting management to rendered applications and to software for carrying out any of the methods. In particular the present invention aims to provide methods, devices, controllers and systems for color processing such as color calibration of displays, to non-volatile (non-transient) memory, controllers, display devices or display systems including at least one transform, e.g. a color calibration transform, to operation of such controllers, display devices or systems and to software for color calibration of a display.

In one aspect, the present disclosure addresses the above objects and aims by separately processing a region or regions of the display based upon the display settings that are appropriate for the particular application delivering content to that region or regions of the display. In this way, for the complete display, or for content (e.g., windows) generated by different applications are transformed such that the content is rendered as intended (even on displays with properties that do not match the display properties expected by the applications).

According to one aspect of the disclosure, there is provided a display system for modifying content of a frame buffer prior to displaying the content of the frame buffer on a display.

The display system is configured to: receive the content of the frame buffer; determine a plurality of regions present in the content of the frame buffer which represent content provided by at least one process; for each determined region, determine desired display settings for the content of the frame buffer located in the determined region; and process the received content of the frame buffer to generate processed frame buffer content. The processing includes, for each determined region present in the content of the frame buffer, determining a processing procedure to modify the content of the determined region such that, when visualized on the display, properties of the content of the determined region coincide with the desired display settings for the determined region. The processing also includes, for each determined region present in the content of the frame buffer, processing the determined region using the determined processing procedure to generate processed frame buffer content. The display system is also configured to supply the generated processed frame buffer content to the display.

Alternatively or additionally, determining the processing procedure comprises determining a type of processing to perform on the content of the frame buffer and determining a data element that, when used to process the content of the frame buffer, performs the determined the type of processing.

Alternatively or additionally, determining the plurality of regions of the frame buffer comprises a user identifying a region and, for each identified region, the user selects desired display settings.

Alternatively or additionally, the desired display settings for a particular determined region are determined based on characteristics of the particular determined region.

Alternatively or additionally, the characteristics of the particular region include at least one of: whether pixels in the particular region are primarily grayscale, primarily color, or a mix of grayscale and color; or a name of the process controlling rendering of the particular region.

Alternatively or additionally, each determined region comprises a geometric shape or a list of pixels representing the content provided by the at least one process.

Alternatively or additionally, the processing procedure comprises at least one of color processing or luminance processing.

Alternatively or additionally, the processing procedure includes luminance processing, which includes applying a luminance scaling coefficient that is computed as the ratio of a requested luminance range to a native luminance range of the display.

Alternatively or additionally, the desired display settings for a particular determined region are based on sRGB, DICOM GSDF, or gamma 1.8 or in accordance with a calibration embodiment of the present invention.

Alternatively or additionally, the determined data element for processing comprises a first transformation element and processing a particular region using the first transformation element. The first transformation element is a three-dimensional (3D) LUT and the content of the 3D LUT is computed from the desired display settings and data stored in an ICC profile for the display.

Alternatively or additionally, the determined data element for processing further comprises a second transformation element and processing the particular region using the first transformation element comprises: processing the particular region using the second transformation element to generate a resultant region and processing the resultant region using the first transformation element. The second transformation element is three one-dimensional (1D) lookup tables (LUTs) and the three 1D LUTs are computed from a mathematical model of the desired display settings.

Alternatively or additionally, the display includes a physical sensor configured to measure light emitting from a measurement area of the display. The display system varies in time the region of the content of the frame buffer displayed in the measurement area of the display. The physical sensor measures and records properties of light emitting from each of the determined regions.

According to another aspect of the disclosure, there is provided a method for modifying content of a frame buffer prior to displaying the content of the frame buffer on a display. The method includes: receiving the content of the frame buffer; determining a plurality of regions present in the content of the frame buffer which represent content provided by at least one process; for each determined region, determining desired display settings for the content of the frame buffer located in the determined region; and generating processed frame buffer content by processing the received content of the frame buffer. The processing includes, for each determined region present in the content of the frame buffer, determining a processing procedure to modify the content of the determined region such that, when visualized on the display, properties of the content of the determined region coincide with the desired display settings for the determined region. The processing also includes, for each determined region present in the content of the frame buffer, processing the determined region using the determined processing procedure to generate processed frame buffer content. The method additionally includes supplying the generated processed frame buffer content to a display.

Alternatively or additionally, determining the processing procedure includes determining a type of processing to perform on the content of the frame buffer and determining a data element that, when used to process the content of the frame buffer, performs the determined the type of processing.

Alternatively or additionally, determining the plurality of regions of the frame buffer comprises a user identifying a region and, for each identified region, the user selects desired display settings.

Alternatively or additionally, the desired display settings for a particular determined region are determined based on characteristics of the particular determined region.

Alternatively or additionally, the characteristics of the particular region include at least one of: whether pixels in the particular region are primarily grayscale, primarily color, or a mix of grayscale and color; or a name of the process controlling rendering of the particular region.

Alternatively or additionally, the processing procedure comprises at least one of color processing or luminance processing.

Alternatively or additionally, the determined data element for processing include a first transformation element and processing a particular region comprises using the first transformation element. The first transformation element is a three-dimensional (3D) LUT and the content of the 3D LUT is computed from the desired display settings and data stored in an ICC profile for the display.

Alternatively or additionally, the determined data element for processing further comprising a second transformation element. Processing the particular region using the first transformation element includes processing the particular region using the second transformation element to generate a resultant region and processing the resultant region using the first transformation element. The second transformation element is three one-dimensional (1D) lookup tables (LUTs) and the three 1D LUTs are computed from a mathematical model of the desired display settings.

Alternatively or additionally, the method includes recording measurements of light emitted from a measurement area of the display using a physical sensor, varying in time the region of the content of the frame buffer displayed in the measurement area of the display, and recording properties of light emitting from each of the determined regions.

An advantage of embodiments of the present is the provision of a processing method which can be a color processing method. For example the color processing can be distribution of color points across a full display gamut (hence optionally preserving full contrast and color saturation in the calibrated display) in an at least substantially perceptually uniform manner. Embodiments of the present invention are less affected by at least one of the problems mentioned above with respect to the prior art. Such embodiments are suitable for use as a color display calibration suited for medical applications. A perceptually uniform manner can be in terms of a distance metric such as deltaE2000 for color or JND for gray.

Embodiments of the present invention provide a color processing method such as a color calibration method comprising the steps:

express a set of color points defining a gamut in a first color space;
map said set of color points from the first color space to a second color space;
redistribute the mapped set of color points in the second color space wherein the redistributed set has improved perceptional linearity while substantially preserving color gamut of the set of points, and
map the redistributed set of color points from the second color space to a third color space.

The result of this method is a color calibration transform. This transform can be stored in a non-volatile LUT memory.

An improved perceptional linearity can be obtained by:

a) Partitioning the first color space gamut using volume filling geometric structures such as polyhedrons, e.g. tetrahedrons;
b) Redistributing color points on the edges of each polyhedron to obtain improved perceptual linearity on the edges of each polyhedron; and/or
Redistributing the color points on the faces of each polyhedron to obtain improved perceptual linearity on the faces by replacing each color point by an interpolated value obtained based on redistributed surrounding points on edges of the polyhedron that form the boundaries of that face of the polyhedron, and/or
Redistributing the color points inside each polyhedron to obtain improved perceptual linearity by replacing each such color point by an interpolated value obtained based on redistributed surrounding faces of the polyhedron containing the inside color point.

The above method perceptually linearizes edges, faces and interior of the polyhedrons.

In another aspect improved perceptional linearity can be obtained by:

a) Partitioning the second color space gamut using volume filling geometric structures such as polyhedrons, e.g. tetrahedrons;
b) Redistributing the color points on edges of each polyhedron to obtain improved perceptual linearity on the edges of each polyhedron; and/or
Redistributing the color points on the faces of each polyhedron to obtain improved linearity of the Euclidean distances between color pointson the faces by replacing each color point by an interpolated value obtained based on the redistributed surrounding points on edges of the polyhedron that form the boundaries of that face of the polyhedron; and/or
Redistributing color points inside each polyhedron to obtain improved linearity of the Euclidean distances between color points inside each polyhedron by replacing each color point by an interpolated value obtained based on the redistributed surrounding faces of the polyhedron containing the inside color point.

The above method perceptually linearizes the edges, then the faces of the tetrahedrons in the second color space while the interior of the tetrahedrons is linearized in the first color space such as an RGB color space in which distance between color points are Euclidean distances.

In another aspect, embodiments of the present invention provide a color calibration method comprising the steps:
expressing a set of color points defining a gamut in a first color space mapping said set of color points from the first color space to a second color space linearizing the mapped set of points in the second color space by making the color points in the second color space perceptually equidistant in terms of one or more color difference metrics throughout the color space, and mapping the linearized set of points from the second color space to a third color space or back to the first color space, to calculate a calibration transform.

With respect to any of the above mentioned embodiments, each color point can be expressed with a number of co-ordinates, e.g. three coordinates in each color space but the present invention is not limited thereto. For example, it can be used with color points having four or more co-ordinates. The coordinates in the second color space are preferably a function of the coordinates of the color points in the first color space. The third color space can be the same as the first color space. The third color space may have a greater bit depth than the first color space.

Any of the methods above can include the step that the set of points in the first color space are measured. In any of the methods above, the color points can be made evenly distributed perceptually by:

dividing the second color space using a plurality of geometrical structures, e.g. polyhedrons such as tetrahedrons which are gamut volume filling;
performing perceptual color point linearizing procedure on the edges, the sides and inside of each tetrahedron and averaging color values derived from the tetrahedrons. The averaging can involve various interpolations between linearized color points. The interpolations are preferably between the faces of the gamut volume and the gray line.

Perceptual linearization involves making color points that are spaced equally or substantially equally in terms of a color difference metric such as the deltaE2000, or with respect to gray points a metric such as JND, . . . . The relevant color space may be selected, for example from native RGB, sRGB, CIE Lab, CIE XYZ, . . . etc.

Embodiments of the present invention conserve the full gamut or substantially the full gamut of the display device by populating the color space starting from outer boundaries of the gamut and working inwards. The calibrated space can be constructed in a way that the color points have improved perceptional linearity, e.g. are equidistant in terms of a color distance metric such as the deltaE2000 while keeping the original shape of the gamut intact or substantially intact.

A color space has a gray line which joins color points having only a gray value which typically will vary from black to white along the gray line. Embodiments of the present invention can conserve the DICOM gray scale e.g. by determining color points by constructing a plurality of geometrical figures that are gamut volume filling to aid in this determining step. The geometric structures can be formed from polyhedrons such as tetrahedrons that share the gray line. Optionally an additional smoothing can be performed to further increase image quality.

Other features of any of the methods above can include any of or any combination of:

setting gray points in the calibrated space having improved perceptional linearity, e.g. equidistant in terms of JND, ensuring DICOM GSDF compliance for gray and/or creating a smooth transition between gray (e.g. JND-uniform or “perceptually linear”) and color (e.g. ΔE2000-uniform) behaviors.

The method may also include the steps of achieving color points with improved perceptional linearity, e.g. equidistant color points (e.g. as defined by the color distance deltaE2000) on gamut edges and then interpolating on gamut faces and from there to within the gamut volume. A color distance such as the deltaE2000 distance is not a Euclidean distance in a color space. The color difference measured by deltaE₂₀₀₀ is only valid locally, i.e. between closely adjacent points.

In another aspect embodiments of the present invention provide a display device or system configured to linearize a color space by the method as described above and in more detail in the description of the illustrative embodiments below. The color calibration method can be used with a display device, for example the calibration transform explained above can be stored in a non-volatile 3D LUT memory in the memory. The color calibration method can also be used with a display system, for example the calibration transform can be stored in a non-volatile 3D LUT memory in the system. For example the non-volatile 3D LUT memory can be in a display controller or associated with a GPU, e.g. in a controller, or in a pixel shader. The color calibration transform can for example be stored in a non-volatile 3D LUT memory.

Embodiments of the present invention provide a color calibration transform stored in a non-volatile LUT memory for a display device, the display device having a native gamut defined in a color space, the calibration transform having a set of calibrated color points derived from the gamut; wherein the calibrated set has improved perceptional linearity compared with the native gamut while substantially preserving a color gamut of the set of points.

Some embodiments of the present invention provide a display device and a method of calibrating and operating such a display device conform with a DICOM calibration based on taking a set of points in a first (input) color scale such as RGB, mapping it to a second perceptually linear color space and then mapping it to a third output color space which can be the same as the input space, e.g. that RGB, wherein color points are equidistance in all of the three dimensions.

In a method of calibrating and operating a display device, an implementation and use of the full gamut of the display device and the gray diagonal is described. An advantage of embodiments of the present invention is that a perceptually linear color space is populated with color points in three dimensions. Embodiments of the present invention additionally comply with the DICOM gray scale calibration (GSDF), which is often a requirement for medical applications. A further advantage is the provision of a visualization method and system able to optimize the complete chain for medical color images, including dealing with the complexity of characterizing and calibrating the visualization system. A further advantage is the provision of a visualization system or method having a known and predictable behavior.

A further advantage is the provision of a visualization system or method available that is optimized to detect features in medical color images, such as digital pathology slides and quantitative medical images. Further the visualization system and method can be made compliant with DICOM GSDF so that the end user does not have to change the visualization system or method or even to adapt the mode of the visualization system or method to examine grayscale images. Finally, the visualization system or method itself can take care of correctly calibrating colors.

Methods, systems and devices according to embodiments of the present invention can optimize the visualization of color images such as medical color images by creating a perceptually uniform color space that makes use of the full available gamut to improve visibility of differences between the background and features instead of relying on color reproduction.

Methods, systems and devices according to embodiments of the present invention can create a hybrid system that are DICOM GSDF compliant, perceptually uniform or can combine DICOM GSDF compliancy with a perceptually uniform color space, using a combination of a 3D LUT and 3×1D LUT.

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

Features that are described and/or illustrated with respect to one embodiment may be used in the same way or in a similar way in one or more other embodiments and/or in combination with or instead of the features of the other embodiments.

### BRIEF DESCRIPTION OF DRAWINGS

FIG. 1 shows a display including multiple windows having content provided by different applications.

FIG. 2 depicts a display system for modifying content of a frame buffer prior to displaying the content of the frame buffer on a display.

FIG. 3 shows an exemplary processing procedure performed by the display system of FIG. 2.

FIG. 4 depicts a method for modifying content of a frame buffer prior to displaying the content of the frame buffer on a display.

FIG. 5 shows an overview of the flow of data in one embodiment of the display system of FIG. 2.

FIG. 6 shows a gamut in an RGB space and the same gamut mapped into CIELAB space.

FIG. 7 illustrates how to calculate deltaE2000.

FIG. 8 illustrates application of deltaE200 color point spacing in an, or for use with any, embodiment of the present invention.

FIGS. 9 and 10 illustrate color points having improved perceptional linearity in a color space and being transformed back to another color space such that the color points are not equidistant in an, or for use with any, embodiment of the present invention.

FIG. 11 illustrates that a straight line in the first color space such as an RGB space is curved in the perceptually linear or uniform color space e.g. CIELAB space.

FIG. 12a shows lines of color points in the gamut cube and FIG. 12b shows how these lines are distorted when the color points are made equidistant in an, for use with any, embodiment of the present invention.

FIG. 13a and FIG. 13b shows how a color point is created on a face of the gamut cube in an, or for use with any, embodiment of the present invention. FIG. 13c indicates how manipulations of points in a perception linear color space can alter gamut boundaries when transformed to an input color space.

FIG. 14a shows regular distribution of color points on a gamut cube and FIG. 14b shows the distribution of color points on 6 faces of the cube in an, or for use with any, embodiment of the present invention.

FIG. 15 indicates how tetrahedrons can be used as volume filling geometric structures in an, or for use with any, embodiment of the present invention.

FIG. 16 and FIG. 17 indicate the manipulations with triangle faces of tetrahedrons to generate points within the tetrahedron in an; or for use with any, embodiment of the present invention.

FIG. 18 illustrates blurring schematically in an, or for use with any, embodiment of the present invention.

FIG. 19a indicates the spatial extent of a Gaussian smoothing filter in an, or for use with any, embodiment of the present invention. FIG. 19b shows cross sections of the color cube illustrating the correction applied as a function of the distance from the gray diagonal/the radius of the gray fields in an, or for use with any, embodiment of the present invention.

FIG. 20 illustrates a flow diagram of an, or for use with any, embodiment of the present invention.

FIG. 21 shows a display system in accordance with an embodiment of the present invention.

### DEFINITIONS

In the text that follows, a “display system” is a collection of hardware (displays, display controllers, graphics processors, processors, etc.), a “display” is considered to be a physical display device (e.g., a display for displaying 2D content, a display for displaying 3D content, a medical grade display, a high-resolution display, a liquid crystal display (LCD), cathode ray tube (CRT) display, plasma display, etc.), a “frame buffer” is a section of video memory used to hold the image to be shown on the display. A “Display or display device or display unit or display system” can relate to a device or system that can generate an image, e.g. a full color image. A display for example may be a back projection display or a direct view display. The display may also be a computer screen or visual display unit or a printed image. A printed image may differ from other displays because it relies on color subtraction whereas other displays rely on color addition.
“Color space”. Images are typically stored in a particular color space, e.g. CIE XYZ; CIELUV; CIELAB; CIEUVW; sRGB; Adobe RGB; Adobe Wide Gamut RGB; YIQ, YUV, YDbDr; YPbPr, YCbCr; xvYCC; CMYK; raw RGB color triplets; . . . ). CIE-L*a*b*, CIE 1976 (Lab) and CIELAB, are different denominations of the same color space.
Some reference documents for Standards:
CIELAB: MCLAREN K. The development of the CIE 1976 (I*a*b*) uniform color-space and color difference formula. Journal of the Society of Dyers and Colorists, vol. 92, pp. 338-341,1976. DOI: 10.1111/j.1478-4408.1976.tb03301.x DeltaE2000 (or CIEDE2000): CIE Publication No. 142. Improvement to Industrial Color-Difference Evaluation. Tech. rep., Central Bureau of the CIE, Vienna, 2001.
A draft of this document is available here: \\bvwsrv01\MID\00 MID-GENERAL\02R&D\01TIG\Projects\tiq administration\tiq bibliography\biblioColorSpace\ CIE01 biblioColorSpace.pdf

### DICOM GSDF:

DICOM.DICOM supplement 28: Grayscale Standard Display Function (GSDF)., 1998.
\\ Bvwsrv01\mid\00 MID-GENERAL\02R&D\01TIG\Projects\tig administration\tig biblioqraphy\biblioDisplay\DIC9 8 biblioDisplay.pdf
“Input or output color space” In order to describe colors, color spaces are known that are defined based on different principles. For example, there is the RGB color space which describes an additive color system, the HSV color space based on saturation, hue and intensity (value) properties of color, the CMYK color space, which describes a subtractive color system. A digital image file may be received with colors defined by one color space which is then called the input color space. The output color space is the color space based on which the color of an image point in the displayed image is determined. The output color space can be, but does not have to be, the same as the initial color space.
“Perceptually linear space” or “Perceptually uniform color space”. A perceptually linear space or a perceptually uniform color space is to be understood as any space for color representation in which the three-dimensional distances between the colors substantially correspond to the color difference that can be perceived by a typical human observer. Hence, in a perceptually linear color space a color difference corresponds to the psychophysical perceived color difference. For example, the CIELab space is based on a mathematical transformation of the CIE standard color space. Such color spaces are described by various names which include CIELUV, the CIE 1976 (Luv), the CIE 1976 (Lab) or the CIELAB color space, for example. Such color spaces can describe all the colors which can be perceived by the human eye. In case of perceptually linear display systems, equal distances in the input signal will also result in equal perceptual color distances. Such a perceptual color difference can be defined by a variety of standards, e.g. by deltaE76, deltaE94, deltaE2000, DICOM GSDF JND, etc. of the visualized output.
“Transforming color spaces”. There are various models for transforming color spaces into perceived color spaces, in which the color difference corresponds to the perceived color difference.
“Color coding/color mappings/color lookup tables (LUTs)” determine how to translate an input set of colors to an output set of colors. Examples of such LUTs are fire LUTs, rainbow LUTs, hot iron LUTs, Hot/heated/black-body radiation color scale, . . . .
Sometimes there is a color management module (such as the ICC color management module (CMM)) that can take care of the appropriate transformation of the image in a particular color space, to raw color values (RGB; RGBW; . . . ) that can be visualized on a display device or system.
“Gamut” as used in this document is a set of realizable colors by an input/output device and takes a different shape in different color spaces. For example, an sRGB's display's gamut can be a cube in its native RGB space (“the native gamut”), is then a diamond-like shape in CIELAB color space and is a parallelogram in CIEXYZ color space. A color space is a possible or ideal set of color points and the gamut refers to a representation of the actual reachable display color points in a certain color space. The display native gamut can be expressed in a certain color space (e.g. RGB, the display world), but this native gamut can also be expressed in CIELAB (the human vision world). In embodiments of the present invention a linearized display gamut expressed in a perceptually uniform space such as CIELAB is converted or transformed from the CIELAB to the display space such as RGB space.
“Geodesic” as used in this document refers to the incrementally shortest path between two points on a surface in terms of a certain distance metric.
“ICC profile”. In color management, an ICC profile is a set of data that characterizes a color input or output device, or a color space, according to standards promulgated by the International Color Consortium (ICC). Profiles describe the color attributes of a particular device or viewing requirement by defining a mapping between the device source or target color space and a profile connection space (PCS). This PCS is either CIELAB (L*a*b*) or CIEXYZ. Mappings may be specified using tables, to which interpolation is applied, or through a series of parameters for transformations (http://en.wikipedia.org/wiki/ICC profile). Since late 2010, the current version of the specification is 4.3.
Every device that captures or displays color can be profiled. Some manufacturers provide profiles for their products, and there are several products that allow an end-user to generate his or her own color profiles, typically through the use of a tri-stimulus colorimeter or preferably a spectrophotometer.
“Oversampled” means that the output (calibrated) color space is oversampled with respect to the input color space when the output color space can have a higher amount of color points. This is advantageous as it means that a calibrated color point can be selected which is close to any color point of the input space. As an example an input RGB space can have color points defined by a bit depth of 8 bits/color, which means that this space has 2²⁴ colors. The output color space could also be an RGB space but with 10 bits/color, i.e. 2³⁰ colors.

### DETAILED DESCRIPTION

The present invention will be described with respect to particular embodiments and with reference to certain drawings but the invention is not limited thereto but only by the claims. The drawings described are only schematic and are non-limiting.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein. The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B. Similarly, it is to be noticed that the term “coupled”, also used in the description or claims, should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

References to software can encompass any type of programs in any language executable directly or indirectly by a processor.

References to logic, hardware, processor or circuitry can encompass any kind of logic or analog circuitry, integrated to any degree, and not limited to general purpose processors, digital signal processors, ASICs, FPGAs, discrete components or transistor logic gates and so on.

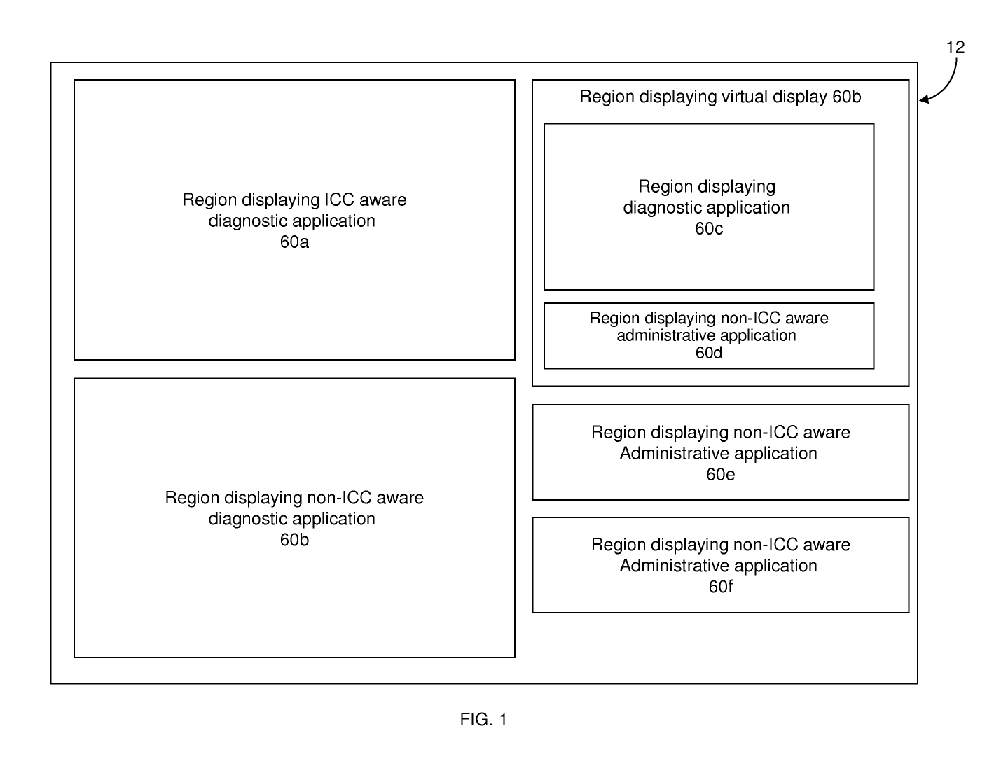

Turning to FIG. 1, a physical display 12 is shown that can be used with any of the embodiments of the present invention, e.g. as described with reference to FIGS. 1 to 5 or 6 to 20. The physical display 12 is adapted to display a single region or multiple regions 60a-f including content from the same or different applications. For example, region 60a of the display 12 includes content generated by a diagnostic application that is aware of the ICC profile of the display 12, while region 60e includes content generated by an administrative application that is unaware of the ICC profile of the display 12. Displaying both diagnostic and administrative applications is a common occurrence in medical environments, where applications often display content that requires a diagnostic level of brightness, while at the same time displaying content from administrative (non-diagnostic) applications. This can cause a problem, because diagnostic applications often require higher levels of brightness than are required for administrative applications. Always offering a diagnostic (high) level of brightness may not be a viable solution, because many administrative applications use white backgrounds that generate extreme levels of brightness when shown on a diagnostic display. These high levels of brightness may cause issues for users attempting to evaluate medical images.

In addition to including both diagnostic and administrative applications, FIG. 1 can include content from a logical display and a virtual display. The different types of applications hosted by the logical display and the virtual display often assume different levels of brightness. Further compounding the problem, a region displaying a virtual display 60b may include regions 60c, 60d having content generated by different types of applications.

In one aspect, the present invention provides a system and method for separately processing content rendered on an attached display. The content (e.g., windows) is or can be provided by different applications. The method and system process the content based upon the display settings that are appropriate for the particular application delivering content to that region of the display. In this way, simultaneously displayed applications (e.g., as shown in FIG. 1) may be processed as intended by each application, independent of differences in the display settings assumed by the displayed applications.

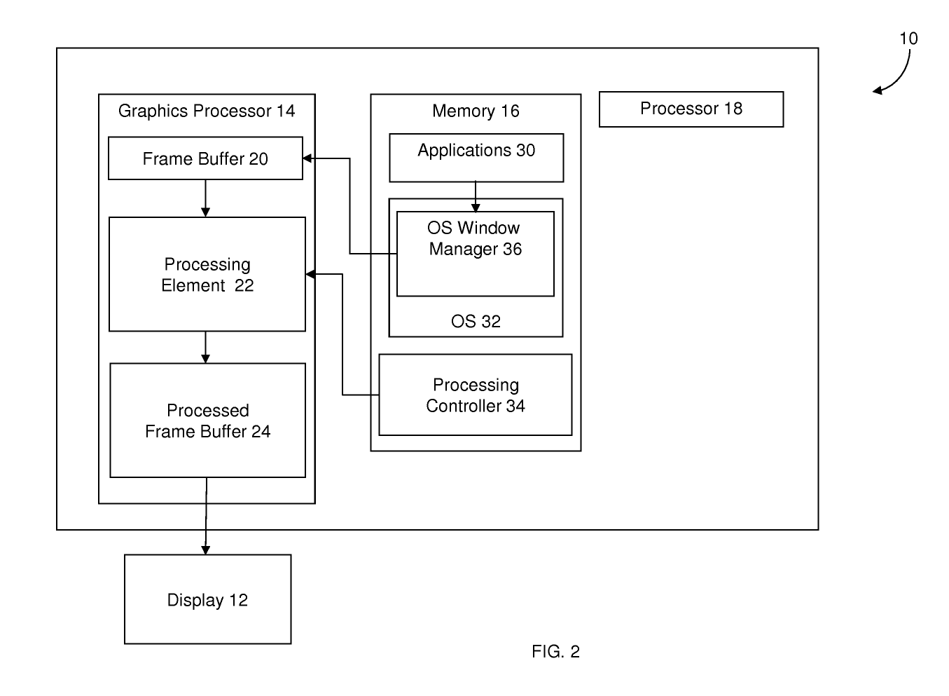

Turning to FIG. 2, an exemplary display system 10 is shown which can be used with any of the embodiments of the present invention, e.g. as described with reference to FIGS. 1 to 5 or 6 to 20. The display system 10 includes an attached display 12 and at least one processor 14, 18. The at least one processor may include a processor 18 and a graphics processor 14. The display system 10 may also include a non-transitory computer readable medium (memory) 16 and a processor 18. The memory 16 may store applications 30, the operating system (OS) 32, and a processing controller 34 that may be executed by the processor 18. When executed by the processor 18, the applications 30 may generate content to be displayed. The display content is provided to the OS window manager 36, which passes the content to a frame buffer 20. The frame buffer 20 is part of the graphics processor 14 and stores display content to be displayed on the display 12. The graphics processor 14 may also include processing elements 22 and a processed frame buffer 24. The processing elements 22 may be controlled by the processing controller 34. The processing elements 22 are located between the framebuffer 20 of the display system 10 and the framebuffers of the attached display 12. The processing elements 22 receive content from the frame buffer 20 and process the content of the frame buffer 20 before passing the processed content to the display 12. In this way, the content rendered on the display 12 is processed by the processing elements 22 of the graphics processor 14 prior to being rendered on the display.

As will be understood by one of ordinary skill in the art, the graphics processor 14 may be an integrated or a dedicated graphics processing unit (GPU) or any other suitable processor or controller capable of providing the content of the frame buffer 20 to the display 12.

As described above, the graphics processor 14 is configured to receive the content of the frame buffer 20. The content may include frames to be displayed on one or more physical displays. When multiple attached displays are present, a separate instance of the processing elements 22 may be present for each attached display. For example, if the display system 10 includes two attached displays 12, then the graphics processor 14 may include a first and second processing element 22.

The processing controller 34 is responsible for directing the processing performed by each of the processing elements 22. The processing controller 34 identifies a plurality of regions 60 within the framebuffer 20. Each region 60 represents a content provided by at least one process. Each region 60 may comprise, e.g., a window. Each region 60 may specify a geometric shape or a list of pixels representing the content provided by the at least one process. A process may refer to an application or program that generates content to be rendered on the display 12.

A single or a plurality of regions 60 of the frame buffer 20 may be determined by a user. For example, a control panel may be displayed to the user that allows the user to identify a region or some or all regions that represent content provided by one or more processes.

Alternatively, the one or a plurality of regions 60 may be automatically determined. For example, one, some or each region 60 present in the content of the frame buffer 20 representing content provided by different processes may be identified. The regions 60 may be identified by interrogating the OS window manager 36. One region, some regions or each identified region 60 may be displayed as a separate window. However, multiple regions (e.g., represented by separate windows) may be combined into a single region. For example, regions may be combined if the regions are generated by the same process, the regions are generated by processes known to require the same display properties, etc.

After determining the one, some or all plurality of regions 60, desired display settings are determined for the content of the frame buffer 20 located in each determined region. The desired display settings may be provided by a user. For example, the control panel that allows a user to identify the regions 60 may also allow a user to assign desired display settings for the regions 60. The display settings may include, e.g., a desired display output profile and desired luminance. The desired display settings indicate the profile of the display 12 expected by the application responsible for rendering the content of the frame buffer 20 located in the particular region 60. For example, a photo viewing application may assume that its images are being rendered on a display 12 with a sRGB profile, and therefore convert all images it loads to the sRGB color space. By selecting “sRGB” as the desired display settings, the rendered content of the application may be processed such that it appears as intended on calibrated displays for which, e.g., an ICC profile is available. Hence the desired display settings may also include a calibration such as a color transform, in particular expressing a set of color points defining a gamut in a first color space, mapping said set of color points from the first color space to a second color space, linearizing the mapped set of points in the second color space by making the color points in the second color space perceptually equidistant in terms of one or more color difference metrics throughout the color space, and mapping the linearized set of points from the second color space to a third color space or back to the first color space, to calculate a calibration transform.

Alternatively, the desired display settings may be determined automatically. For example, the desired display settings for a particular region may be determined based upon characteristics of the particular region. The characteristics of the particular region may include whether pixels in the particular region are primarily grayscale, primarily color, or a mix of grayscale and color. The characteristics of the particular region may alternatively or additionally include a name of the process controlling rendering of the particular region.

In one example, regions rendered as pure grayscale pixels may have their display settings calibrated to the DICOM grayscale standard display function (GSDF) curve. Similarly, all applications that have rendered content with more than 80% of the pixels in color may have desired display settings corresponding to the sRGB standard. In another example, all other applications may have desired display settings corresponding to gamma 1.8. The adaption to a specific rendering process may also include a calibration such as a color transform, in particular expressing a set of color points defining a gamut in a first color space, mapping said set of color points from the first color space to a second color space, linearizing the mapped set of points in the second color space by making the color points in the second color space perceptually equidistant in terms of one or more color difference metrics throughout the color space, and mapping the linearized set of points from the second color space to a third color space or back to the first color space, to calculate a calibration transform.

The desired display settings may also be determined automatically using the name of the process controlling rendering of the particular region. In this example, the memory 16 may include a database listing identifying process names associated with desired display settings. The processing controller 34 may determine which regions are being rendered by which processes and set the appropriate desired display settings for each region by applying the desired display settings as specified in the database. Processes that do not appear in the database may be set to a default desired display setting (e.g. based on DICOM GSDF or sRGB or a color calibration calculated in accordance with embodiments of the present invention). As will be understood by one of ordinary skill in the art, the database may be managed locally or globally.

After determining the desired display settings for one or some or each determined region, the content of the frame buffer 20 is processed to generate processed frame buffer content. Processing the content of the frame buffer 20 includes, for each determined region present in the content of the frame buffer 20, determining a processing procedure to modify properties of the content of the determined region to coincide with the determined desired display settings for the region. That is, a processing procedure is determined that will modify the properties of the content of the determined region to match the determined desired display settings for the region. Matching the properties of the content of the determined region and the desired display settings may not require the properties to exactly match the display settings. Rather, the properties of the content may be processed to approximately match the desired display settings. “Approximately match” may refer to the properties of the content matching within at least 25%, at least 15%, or at least 5% the desired display settings. For example, if the desired display setting specify 500 lumens, the properties of the content may be modified to be within 15% of 500 lumens (e.g., 425 lumens to 575 lumens).

Determining the processing procedure for a particular determined region may include determining a type of processing to perform. For example, the type of processing may include at least one of color processing or luminance processing. For example, the type of processing may include at least one of color calibration processing. The type of processing may be determined based upon the desired display settings for the particular determined region and the known properties of the display 12. For example, the display 12 may store an ICC profile for the display 12. The type of processing may be determined based upon differences between the ICC profile for the display 12 and the desired display settings for the particular determined region. For example, the differences between the desired display settings for the particular region and the ICC profile for the display 12 may require only linear processing, only non-linear processing, or both linear and non-linear processing.

The processing procedure to perform for each determined region may include a number of processing steps necessary to modify properties of the content for the particular determined region to coincide with the desired display settings for the particular region.

In addition to determining the type of processing, determining the processing procedure to perform for each identified region may additionally include determining a data element 70 that, when used to process the content of the frame buffer 20, performs the determined type of processing.

In one example, the type of processing for a particular determined region is luminance processing, which includes luminance scaling. The processing procedure includes applying a data element 70 that includes a luminance scaling coefficient. The data element 70 (i.e., the luminance scaling coefficient) is determined based upon a requested luminance range that is part of the desired display settings. In particular, the luminance scaling coefficient is computed as the ratio of the requested luminance range to a native luminance range of the display 12. The native luminance range of the display 12 may be determined by an ICC profile for the display 12.

Luminance correction may be performed on a display 12 having a response following the DICOM GSDF by applying a data element 70 including a single luminance scaling coefficient. The DICOM GSDF ensures that drive level values are proportional to display luminance in just noticeable differences (JNDs). The coefficient (c) applied to such a display 12 may be computed as follows:

$$c = \frac{Y2 JND ( newLum ) - Y2 JND ( min Lum )}{Y2 JND ( max Lum ) - Y2 JND ( min Lum )}$$

where:

newLum=desired maximum luminance specified in display settings;

minLum=minimum displayable luminance (e.g., considering ambient light) as specified in display settings;

maxLum=maximum displayable luminance; and

Y2JND(L)=inverse of the GSDF JND to luminance function, as provided by the following formula from page 12 of the DICOM GSDF spec:

j(L)=A+B Log₁₀(L)+C(Log₁₀(L))²+D(Log₁₀(L))³+E(Log₁₀(L))⁴+F(Log₁₀(L))⁵+G(Log₁₀(L))⁶+H(Log₁₀(L))⁷+I(Log₁₀(L))⁸

where, A=71.498068, B=94.593053, C=41.912053, D=908247004, E=0.28175407, F=−1.1878455, G=−0.1801439, H=0.14710899, I=−0.017046845.

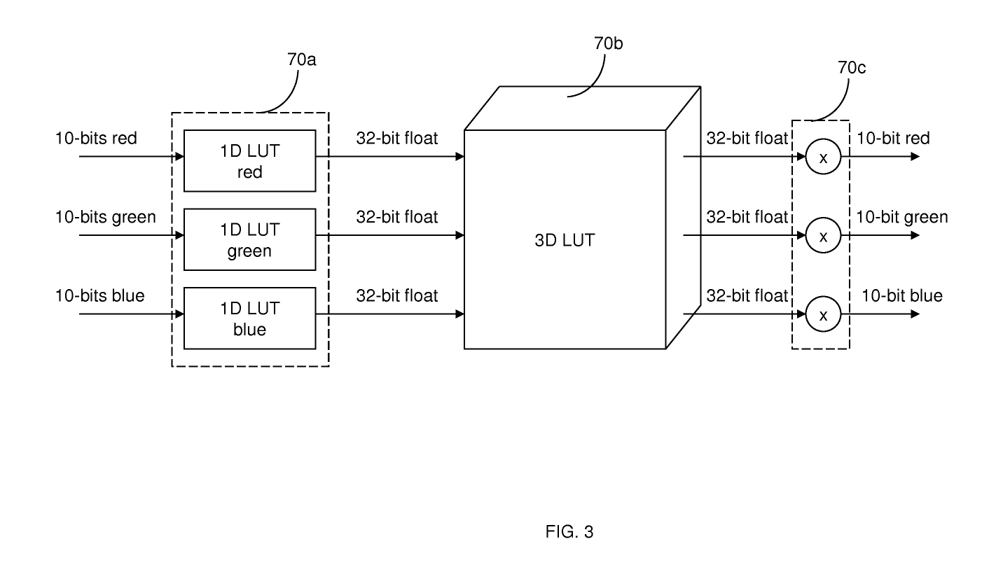

In the example shown in FIG. 3, the processing procedure for a particular determined region includes linear color processing and non-linear luminance processing. The data element 70 for this processing procedure may include a first transformation element 70a used to perform the linear color processing and a second transformation element 70b used to perform the non-linear luminance processing. Processing a particular region may comprise first processing the particular region using the first transformation element 70a to generate a first resultant region. Next, the first resultant region may be processed using the second transformation element 70b.

The first transformation element 70a may be three one-dimensional (1D) lookup tables (LUTs). The three 1D LUTs may be chosen to provide the per-color-channel display response specified in the desired display settings for the particular determined region. The first transformation element 70a may be computed from a mathematical model of the desired display settings and a profile of the display 12. The three 1D LUTs may take 10-bit-per-channel values as an input and provide 32-bit-float values for each channel as an output.

The second transformation element 70b may be a three-dimensional (3D) LUT. The 3D LUT may be computed to invert the non-linear behavior of the display 12 to be linear in the particular determined region. Each entry in the 3D LUT may contain three color channels for red, green, and blue, each represented at 10-bits per channel. The second transformation element 70b may have a size of 32×32×32. Tetrahedral interpolation may be applied to the second transformation element in order to estimate color transformation for color values not directly represented by the second element 70b. The content of the 3D LUT may be computed from data stored in the ICC profile of the display 12 and the display settings.

The net effect of processing a particular region using the first and second transformation elements 70a, 70b is a perceptual mapping of the desired display gamut (e.g., sRGB) specified in the display settings to the display's actual gamut. When the gamut of the display 12 and the gamut specified in the desired display settings differ significantly, it may be necessary to perform an additional correction in the 1D or 3D LUTs that takes into account the colors that are outside the displayable gamut. For example, one approach is to apply a compression of chrominance in Lab space (such that the colors within the displayable gamut are preserved to the extent possible). In the compression, the chrominance of colors near the gamut boundary are compressed (while preserving luminance) and colors outside the gamut are mapped to the nearest point on the gamut surface.

As shown in FIG. 3, the data element 70 may additionally include a luminance scale factor 70c. The luminance scale factor 70c may be used to process the result of the second transformation element 70b.

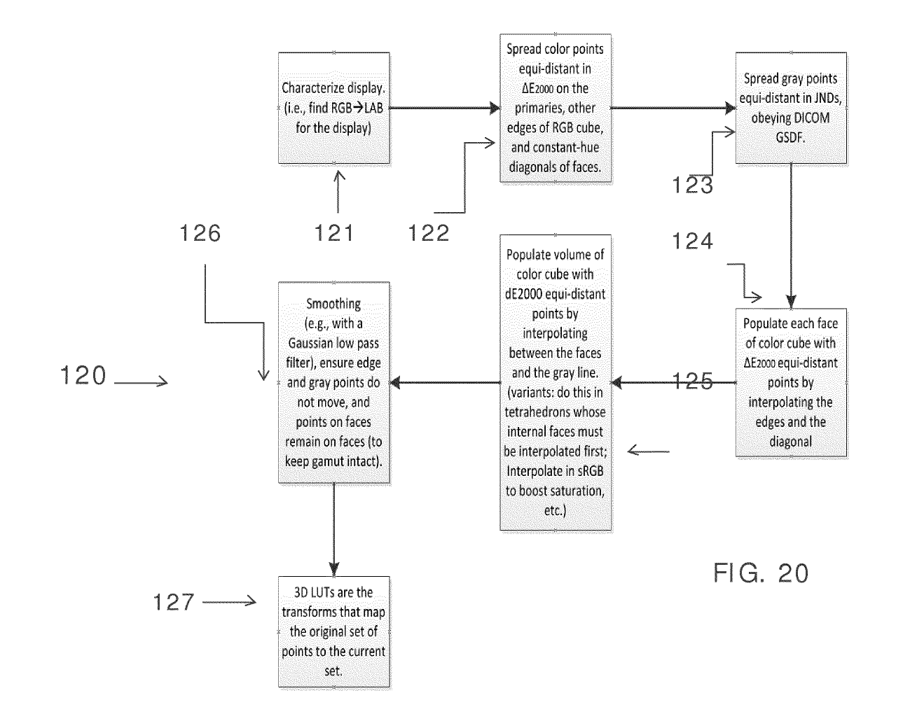

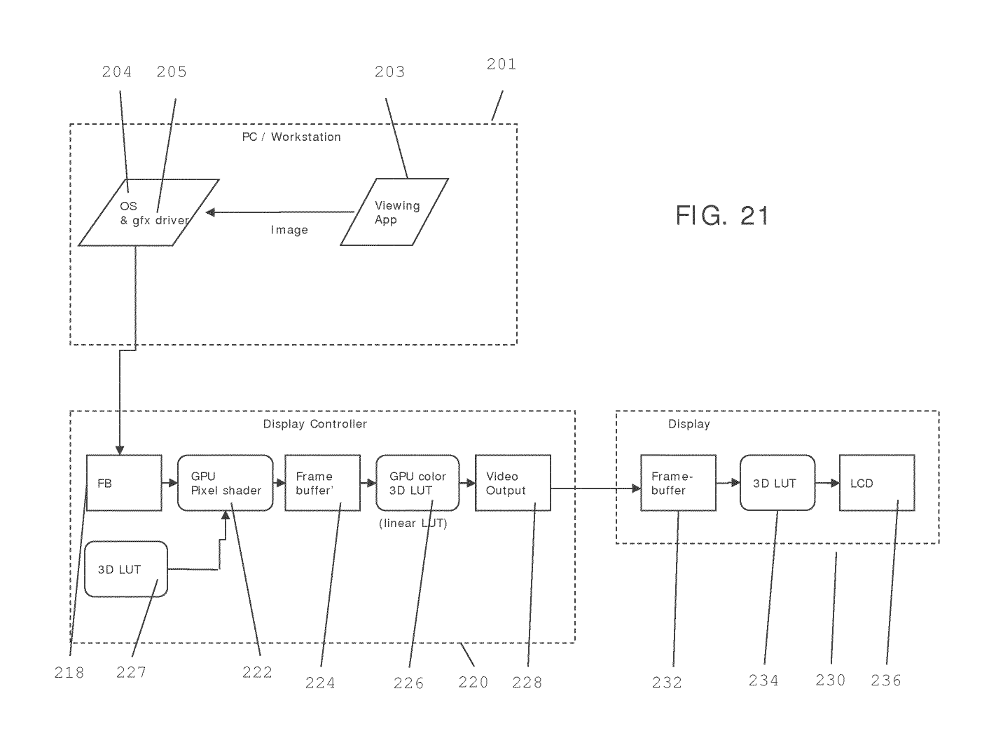

While the above processing is described using three 1D LUTs and a 3D LUT, other embodiments may change the roles of each LUT, remove one of the LUTs entirely, or add additional LUTs (see FIG. 21, for example) or processing steps (see FIG. 20, for example) as necessary to process the content of the particular region to match as close as possible the desired display settings.

The content of the three 1D LUTs may be computed from a mathematical model of the desired display settings. The content of the 3D LUT may be computed from data stored in the ICC profile of the display 12 that describes how to compute the necessary driving level to achieve a desired color output (e.g., using the BtoA1 relative colorimetric intent tag). For example, the second transformation element 70b may be generated by computing the inverse of a 3D LUT that is programmed into the display 12 to achieve its calibrated behavior. For improved performance and quality, the 3D LUT may be pre-computed and directly stored into the ICC profile of the display 12.

In addition to determining the processing procedure, processing the content of the frame buffer 20 also includes, for each determined region, processing the determined region using the determined processing procedure to generate processed frame buffer content. The processed frame buffer content may then be placed into the generated processed frame buffer 24. Alternatively, the processed frame buffer content may be placed into the frame buffer 20. In either case, the processed frame buffer content is supplied to the display 12.

Processing the frame buffer 20 may be iteratively performed for each frame. That is, the same processing procedure may be repeatedly performed for each frame. The processing procedure may be maintained until the framebuffer changes. That is, the frame buffer 20 may be monitored for a change in the properties of the regions 60. For example, the frame buffer 20 may be monitored to detect a change in the location or size of at least one of the regions 60. When a change in the regions 60 is detected, the regions present in the content of the frame buffer 20 may be determined, again the desired display settings for the newly determined regions 60 may be determined, and the content of the frame buffer 20 may again be processed to generate the processed frame buffer. The desired display settings and the processing procedure may only be determined for new regions or regions with different properties. For example, if a new window is opened, the desired display settings and the processing procedure may only be determined for the new window while the desired display settings and processing procedure for the previously determined regions may be unchanged.

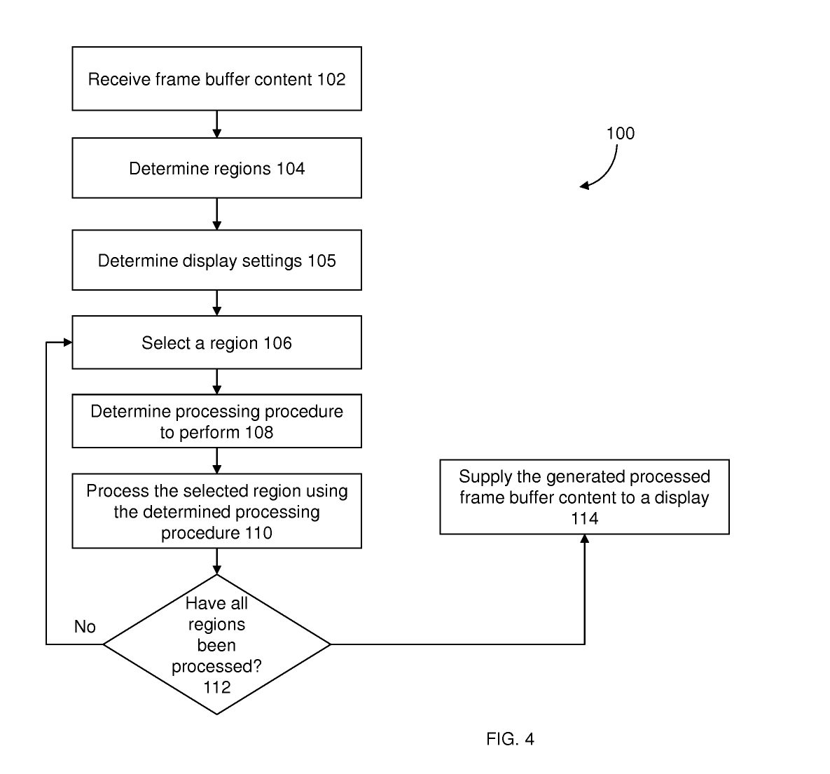

Turning to FIG. 4, a flow diagram for a method for modifying content of a frame buffer 20 prior to displaying the content of the frame buffer 20 on a display 12 is shown. As will be understood by one of ordinary skill in the art, the method may be performed by the at least one processor 14, 18. For example, the method may be performed by a processing controller program stored in a non-transitory computer readable medium 16, which, when executed by the processor 18 and/or graphics processor 14, causes the processor 18 and/or the graphics processor 14 to perform the method.

In process block 102, the content of the frame buffer 20 is received. The content of the frame buffer 20 may be received by the graphics processor 14. In process block 104, the plurality of regions present in the content of the frame buffer 20 are determined. In process block 105, desired display settings are determined for each determined region. Process blocks 104 and 105 may be performed by the processor 18.

In process block 106, a given determined region is selected. In process 108, the processing procedure to perform is determined. For example, as described above, determining the processing procedure may be determined based upon the desired display settings for the given determined region and a profile of the display 12. Process block 106 and 108 may be performed by the processor 18. In process block 110, the given determined region is processed using the determined processing procedure. Processing of the given determined region may be performed by the processing elements 22 of the graphics processor 14.

In decision block 112, a check is performed to determine if all regions have been processed. If there exists any regions that have not yet been processed, then processing returns to process block 106, where an unprocessed region is selected. Alternatively, if all of the regions have been processed 112, then the generated processed frame buffer content is supplied to the display 12 by the graphics processor 14.

Using the method 100 described above, a user may indicate desired display settings for particular applications and the content of these applications may be processed regardless of their location on the display 12. The method does not depend upon the capabilities of the applications and does not require any involvement from the application vendor.

The method 100 may be accelerated using parallel computing hardware in the graphics processor 14. By utilizing the graphics processor 14 to execute aspects of the method 100, it is possible to process frame buffer content and keep up with 60 Hertz (Hz) display refresh rates even for large resolutions and/or multiple displays 12.

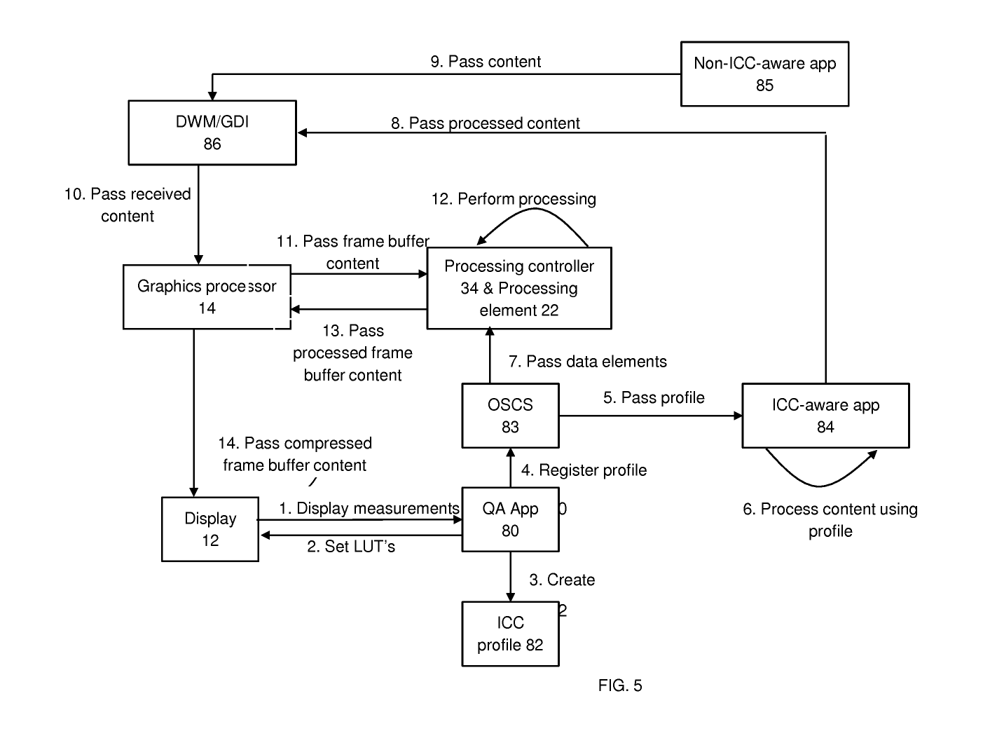

Turning to FIG. 5, an overview of the flow of data in one embodiment of the system is shown. Beginning at the display 12, display measurements are passed to a QA management application 80. The QA management application 80 sets LUTs for the display 12 and passes the LUTs back to the display 12 for storage. The QA management application 80 additionally creates an ICC profile 82 for the display 12. The ICC profile 82 may include inverse LUTs (i.e., data elements 70) for processing of frame buffer content. The QA management application 80 registers the created ICC profile 82 with an OS Color System (OSCS) 83. The OSCS provides APIs for applications to indicate color profile information from source devices and also for destination devices, and APIs to request that the OS (or any registered color management module) perform the necessary color transformations, including transforming images to intermediate color spaces.

The OSCS 83 passes the ICC profile 82 to any ICC-aware application(s) 84. The ICC-aware application(s) 84 render content that is passed to a Desktop Window Manager/Graphics Device Interface (DWM/GDI) 86 that is part of the OS. Non-ICC-aware applications 85 similarly render content that is passed to the DWM/GDI 86. The DWM/GDI 86 passes the received content to the graphics processor 14, which places the content in the frame buffer 20.

The graphics processor 14 passes the content of the frame buffer 20 to the processing controller 34 and the processing element 22. The OSCS 83 passes the data elements 70 from the ICC profile 82 to the processing controller 34 and the processing element 22. The processing controller 34 and the processing element 22 perform the method 100 described above and return generated processed frame buffer content to the graphics processor 14. The graphics processor 14 then passes the processed frame buffer content to the display 12, which displays the processed frame buffer content.

Applications running in a Virtual Desktop Infrastructure (VDI) are typically unable to obtain the color profile for the remote display on which the applications are displayed. This is true regardless of whether the applications are non-ICC aware or ICC-aware. This can be especially problematic when multiple users may be viewing the same virtual session using different displays. In this case, it is not possible for typical applications to provide specific desired display settings by processing the display content being delivered, because different processing is required for each client. As will be understood by one of ordinary skill in the art, a virtual display may be a remote desktop connection, a window to a virtual machine, or belong to a simulated display.

The display system 10 solves this problem by performing processing using the graphics processor 14 of the remote computer receiving the display content. For example, a user of the client may use the control panel described above to select an appropriate color profile for the region hosting the remote session. This profile may apply to all applications in the remote session. Alternatively, a user may use the control panel to select an appropriate color profile for each region rendered in the remote session. In this way, the region present in the remote session may be displayed as expected by the rendering applications.

Screen captures are a common means for capturing and sharing image content for viewing on other display systems. In order to ensure accurate reproduction of the screen capture on other systems, the display system 10 embeds an ICC profile in the screen capture that corresponds to the display 12 used at the time of the screen capture. By embedding the ICC profile in the screen capture, it is possible for a different display system to process the screen capture such that a reproduction of the screen capture rendered on the different display system is faithful to the screen capture. This is true even when the screen capture includes multiple applications with different desired display settings.

It is especially important for healthcare applications that images are rendered correctly. Traditionally medical displays have used display calibration and display quality assurance (QA) checks to ensure that a display system is rendering applications or images as expected. However, in situations with multiple non-ICC aware applications it is not possible to accurately calibrate the display of each non-ICC aware application, because QA checks are performed on the display 12 as a whole (i.e., not for individual applications rendered on the display 12). A solution is needed that allows efficient calibration and QA checks of display systems that will be used to render multiple non-ICC-aware applications simultaneously on the same display.

Some countries, by law or regulation, require a periodic calibration and QA check to prove that images viewed on a display meet a minimum quality requirement.

Calibration and quality assurance (QA) checks are typically performed on a “display level”, meaning that the display is calibrated as a whole to one single target and QA checks are performed for the display as a whole. A calibration and/or QA check performed in this manner can only show that applications that correspond to the calibration target the display 12 was calibrated for were correctly visualized. For all other applications there is no guarantee, nor proof that the applications/images were correctly visualized.

If the contents of the frame buffer 20 is composed of multiple virtual displays, or if the frame buffer contents contains multiple applications with different display requirements, then it is necessary to perform a QA check for each region. This is often not possible, because sensors used to perform QA checks typically can only measure performance of the display at one static location on the display 12.

In one embodiment, the display includes a physical sensor configured to measure light emitting from a measurement area of the display. In order to calibrate the display 12 using the sensor for regions generated by different applications, the area under the sensor is iterated to display different regions. That is, the display system varies in time the region of the content of the frame buffer displayed in the measurement area of the display. This automatic translation of the region displayed under the sensor allows the static sensor to measure the characteristics of each displayed region. In this way, the physical sensor measures and records properties of light emitting from each of the determined regions. Using this method, calibration and QA reports may be generated that include information for each application responsible for content rendered in the content of the frame buffer 20. One method for driving the calibration and QA is to post-process measurements recorded by the sensor with the processing that is applied to each measured region. An alternative method for driving the calibration and QA is to pre-process each rendered region measured by the sensor.

In order to stop the calibration and QA checks from becoming very slow (because of the large number of measurements needed to support all of the different regions), a system of caching measurements may be utilized. For the different display settings that need to be calibrated/checked, there may be a number of measurements in common. It is not efficient to repeat all these measurements for each display as setting since this would take a lot of time and significantly reduce speed of calibration and QA as a result. Instead, what is done is that a “cache” will be kept of measurements that have been performed. This cache contains a timestamp of the measurement, the specific value (RGB value) that was being measured, together with boundary conditions such as backlight setting, temperature, ambient light level, etc.). If a new measurement needs to be performed, the cache is inspected to determine if new measurement (or a sufficiently similar measurement) has been performed recently (e.g., within one day, one week, or one month). If such a sufficiently similar measurement is found, then the measurement will not be performed again, but the cached result will instead be used. If no sufficiently similar measurement is found in the cache (e.g., because the boundary conditions were too different or because there is a sufficiently similar measurement in cache but that is too old), then the physical measurement will be performed and the results will be placed in cache.

As will be understood by one of ordinary skill in the art, the processor 18 may have various implementations. For example, the processor 18 may include any suitable device, such as a programmable circuit, integrated circuit, memory and I/O circuits, an application specific integrated circuit, microcontroller, complex programmable logic device, other programmable circuits, or the like. The processor 18 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor. The processor 18 may be communicatively coupled to the computer readable medium 16 and the graphics processor 14 through a system bus, mother board, or using any other suitable structure known in the art.

As will be understood by one of ordinary skill in the art, the display settings and properties defining the plurality of regions may be stored in the non-transitory computer readable medium 16.

The present disclosure is not limited to a specific number of displays. Rather, the present disclosure may be applied to several virtual displays, e.g., implemented within the same display system.

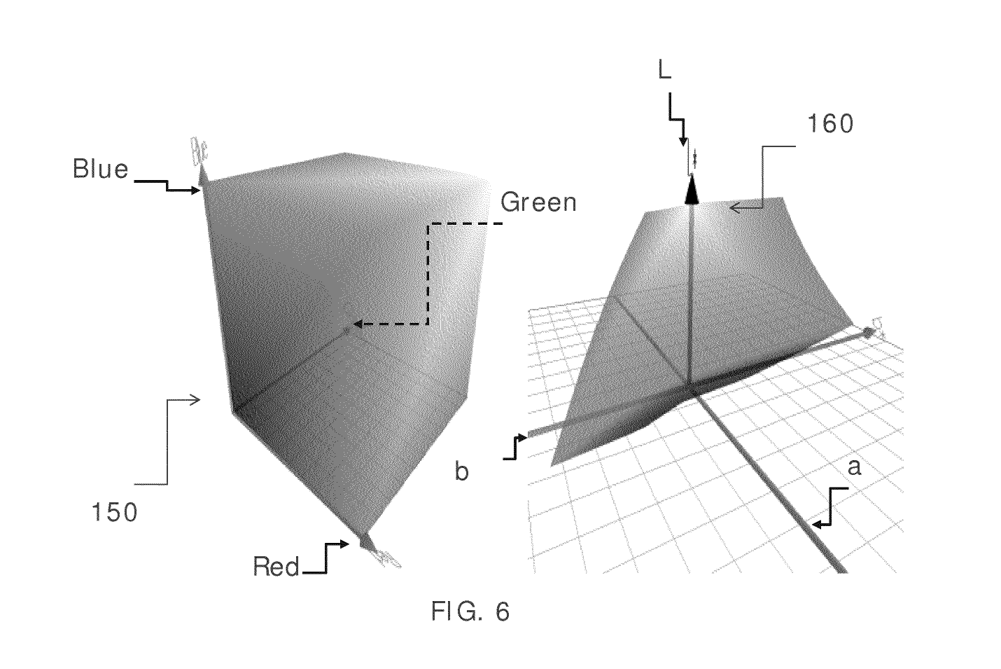

The following embodiment describes one method to achieve a desired color output. This embodiment of the present invention is independent and may be claimed independently. The embodiment will be described with respect to FIGS. 6 to 20 but it should be understood that this calibration method is preferably included with any of the embodiments described with respect to FIGS. 1 to 5, and this combination is explicitly disclosed herewith. FIG. 6 shows a gamut, i.e. the set of realizable colors by a display device for example the display device of FIG. 1 or 2 or the display 236 of FIG. 21, in two color spaces which is assumed to be known. In color space 150, the gamut fills a volume, in this case a cube. This color space is an input color space for example a display native RGB color space. The cube has three axes, of red, green and blue color co-ordinates. This space is not a perceptually linear or uniform space. This color space could be selected for example because it is convenient when transferring images over a network. The same gamut is shown in color space 160, when transformed into a perceptually linear or uniform space such as CIELAB or CIELUV. The shape of the gamut is not the same in different color spaces. The distances between two color points in color space 160 is closer to their perceived difference. The present invention in embodiments includes a display model or measurements that express how the gamut is mapped from color space 150 (e.g., native RGB space) to color space 160 (e.g., CIELAB, a perceptually uniform space).

The next step is to populate the constant-hue lines that make up the outer edges of the gamut in color space 150 with color points having improved perceptional linearity, e.g. equidistant perceptually (e.g., equidistant in color space 160 or in terms of dE2000, for example). With reference to the gamut in color space 150 these are straight lines but the present invention is not limited thereto. Once the color points having improved perceptional linearity, e.g. are equidistant, have been generated for a complete gamut in color space 160, the calibrated color space will be transformed into an output color space which is the color space of a display device. It is preferred if the display device (whose color response is defined in an output color space) has a larger number of potential color points than the input color space. This means that the output color space is oversampled with respect to the input color space. This is advantageous as it means that a calibrated color point can be selected which are very close to any color point of the input gamut.

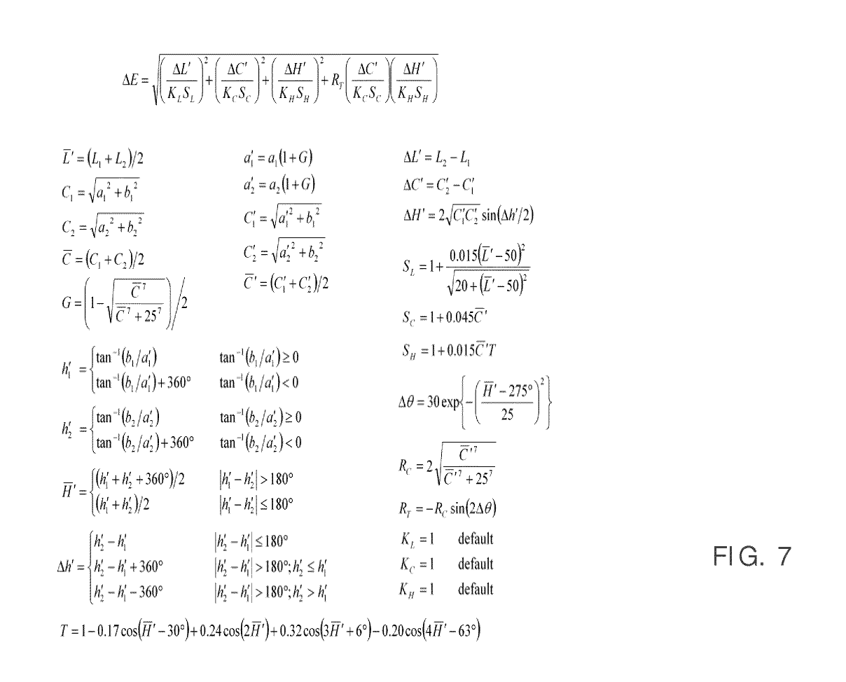

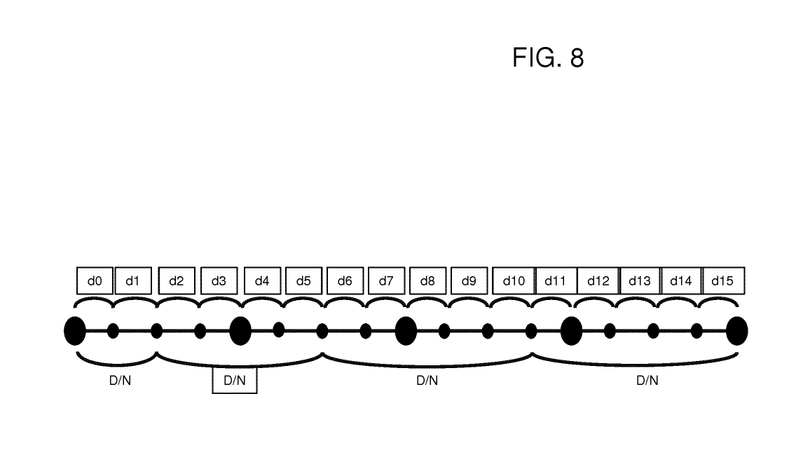

In order to populate color points having improved perceptional linearity, e.g. equidistant in color space 160 along edges or diagonals of the gamut (color cube) of color space 150, a distance metric is calculated in color space 160 which is going to be the selected distance between color points. This metric can be any suitable color distance metric, for example any of deltaE76, deltaE94, deltaE2000. For gray points any suitable gray distance metric can be used, for example DICOM GSDF JND, or similar. For example for placing color points having improved perceptional linearity, e.g. equidistantly on diagonals or edges deltaE2000 can be selected which is defined by the formulae in FIG. 7. Note that deltaE2000 is not a Euclidean distance in CIELAB and that its predicted color difference is valid only when comparing nearby colors. Accordingly, the color distance metric such as deltaE2000 is calculated and used for the separation between successive (oversampled) points (d0 to d15) and these distances are then summed to the total length of the diagonal or edge. This is shown schematically in FIG. 8 where the total distance, D, is given by the sum: D=Σdᵢ.

The new color points are selected from the oversampled set to have improved perceptional linearity, e.g. be perceptually equidistant. The variables of FIG. 8 are: d₀ to d₁₅ are the deltaE2000 distances between oversampled points along a color line D is the sum of d₁ to d₁₅ (i.e. the total length of the color line).

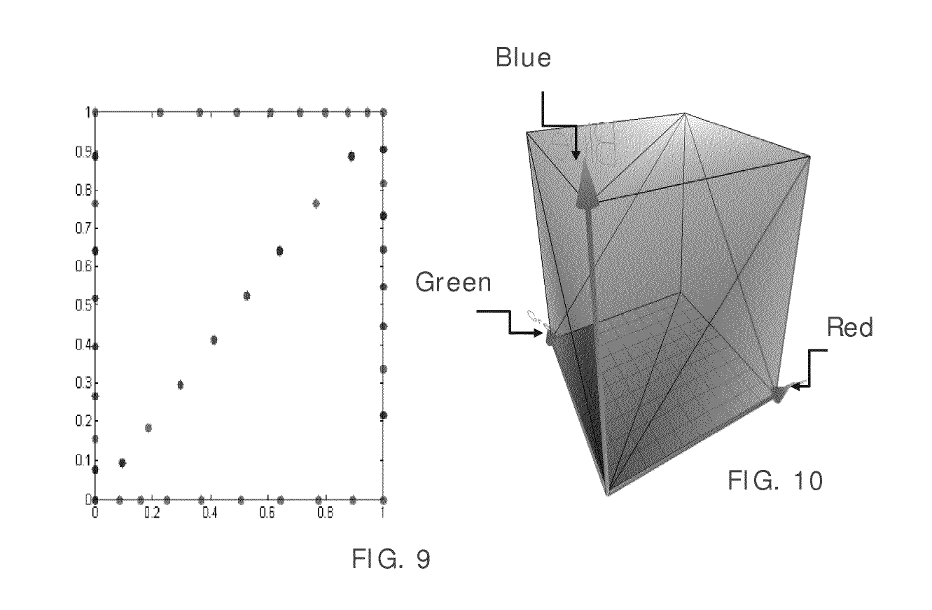

D/N is the total ΔE₂₀₀₀ length of the color line divided by the number of points that are wanted on this line. FIG. 8 represents a color line in RGB space, while distances presented are expressed in CIELAB color space (deltaE2000). For example, if N+1 color points are desired on an edge of the gamut (e.g., N=255 when each color channel is expressed in 8 bits), the selected points are chosen to have a sum of d, and hence a distance of D/N in between them. Such placement of color points yields a one dimensional perceptual color uniformity. This procedure is carried out for all edges of the gamut (color cube) in color space 1, as well as one diagonal per face, i.e. the one going from lowest to highest luminance of the face; see FIG. 9 and FIG. 10.

When the color points having improved perceptional linearity in color space 160, e.g. in a CIELUV, the CIE 1976 (Luv), the CIE 1976 (Lab) or the CIELAB color space 160, are transformed back to the input color space 150 (or to another output color space) such as an RGB color space the color points are not equidistant as shown in FIG. 9 and FIG. 10. However as the points have been calculated to have improved perceptional linearity, e.g. be equidistant in color space 160, these color points in color space 150 are perceptually linear.

The next step is to populate each of the side surfaces (i.e. faces) of the gamut volume (color cube) in color space 150. The points will be populated along deltaE2000 (or other color difference metric of choice) geodesics connecting the points on edges to the corresponding points on the diagonal of each face. A geodesic is the incrementally shortest path between two points on a surface in terms of a certain distance metric.

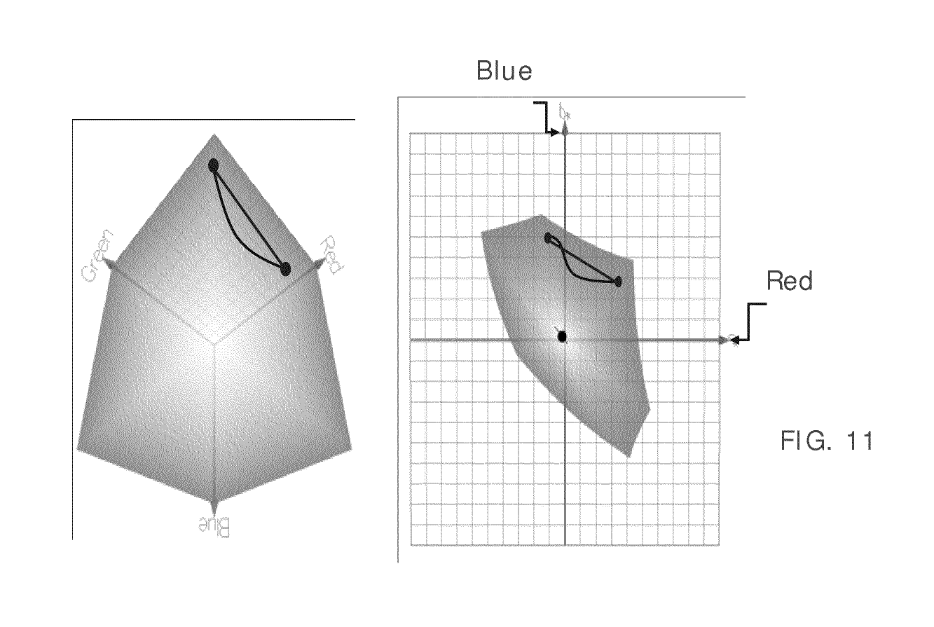

Straight lines in CIELAB, which are dE76 geodesics, may be used as computationally low-cost approximations of deltaE2000 geodesics. A straight line in the first color space 150 such as an RGB space is curved in the perceptually linear or uniform color space 160 e.g. CIELAB space as shown in FIG. 11 with color space 150 on the left and color space 160 on the right. On each line in color space 160 which can be e.g. as variously described as CIELUV, the CIE 1976 (Luv), the CIE 1976 (Lab) or the CIELAB color space, color points are distributed equidistantly using a color distance metric such as to define the distance between points on each line in perceptually linear or uniform space 160 such as deltaE76, deltaE94, deltaE2000, DICOM GSDF JND, in the L*a*b color space. The extremities of each line are defined in the first color space 150 such as the RGB space, then converted to the CIELab color space 160 or as named such as CIELUV, the CIE 1976 (Luv), the CIE 1976 (Lab) or the CIELAB color space. The method continues as before with providing more points in the color space 160 than in color space 150 (oversampling), computation of the distances from the distance metric and selection.

Considering half-faces of the gamut (color cube) of color space 150 as shown in

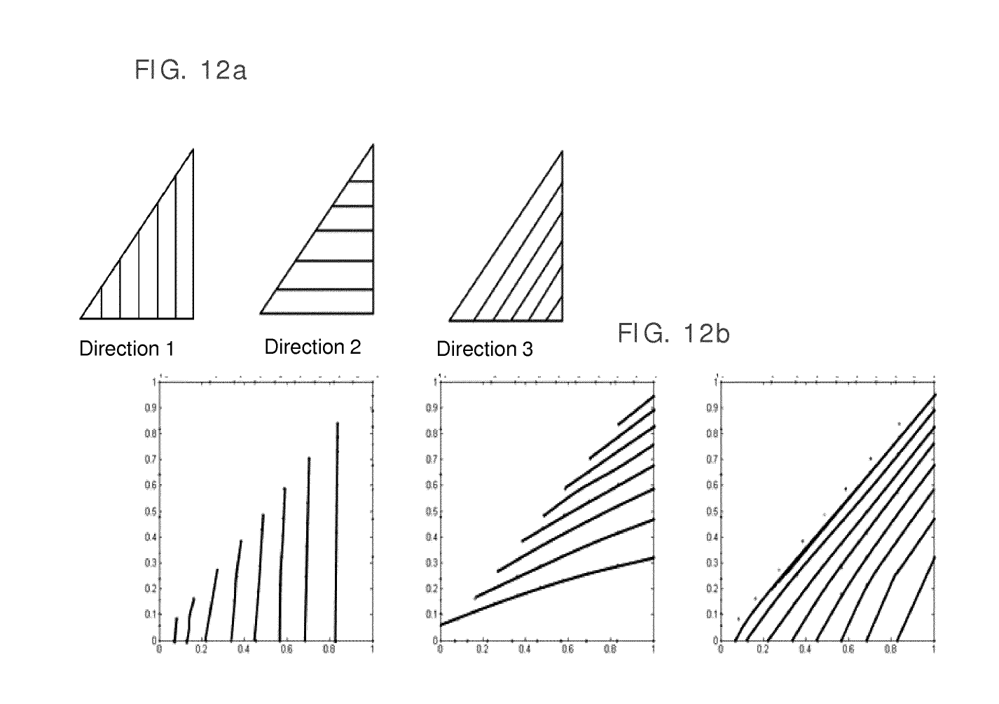

FIG. 12a color points are distributed to have improved perceptional linearity, e.g. equidistantly along lines in 3 different directions 4,5,6 using the color distance metric such as DeltaE2000. The lines shown are (e.g. approximations of) the deltaE2000 geodesics on the gamut face that connect the equidistant set of points on the edges to the corresponding points on another edge or the face diagonal. The resulting points on the lines are converted back to color space 150 such as the RGB space as shown in FIG. 12b. If all driving levels of the display are sampled, then the distance between two lines in the calibrated display is one driving level of the display.

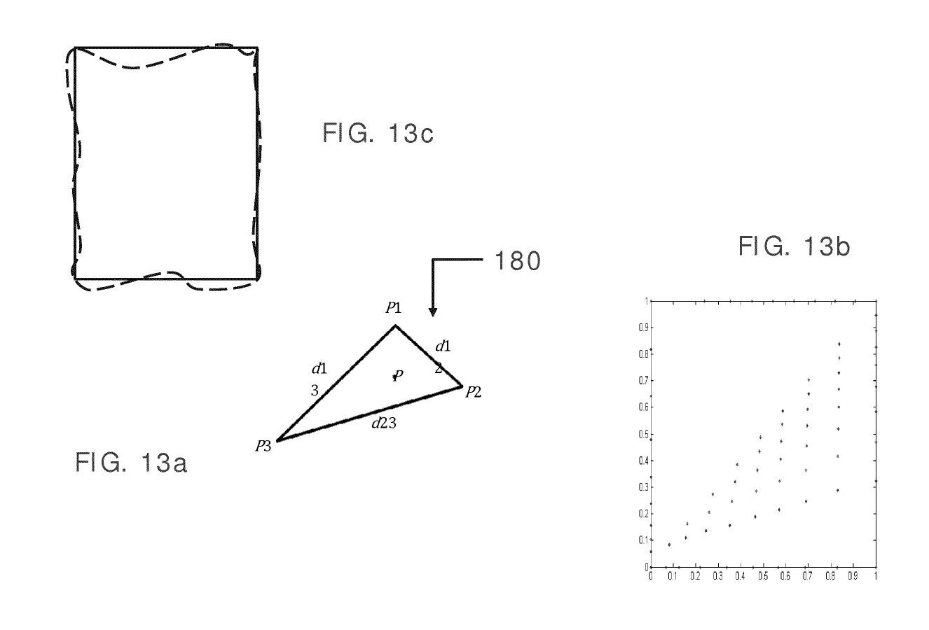

Hence the color points are distributed between edges and diagonals of the gamut (color cube) of color space 150 such as the RGB space to create some triangles in those 3 directions 4, 5, 6) (e.g. Horizontal edge to diagonal, Vertical edge to diagonal, Horizontal edge to Vertical edge). Thus there will be three candidate positions P1, P2, P3, each resulting from one of the interpolations, which surround any point P on the half-face. Lines connecting P1, P2, P3 form a triangle 180 as shown in FIG. 13a. The point P, that makes up the perceptually uniform distribution on the face, is obtained from P1, P2, P3. For example, a weighted average can be used. The weighting may be based on the Euclidean distance between the edges of the triangle in the color space 150 such as the RGB space or lengths of the corresponding geodesics in color space 160; see FIG. 13a. For example the point P is located at a position defined by

$$P = \frac{{P}_{1} * {d}_{23} + {P}_{2} * {d}_{13} + {P}_{3} * {d}_{12}}{{d}_{23} + {d}_{13} + {d}_{12}}$$

The result of this averaging process for a half-face is shown in FIG. 13b in color space 150 such as the RGB space (the lines are not straight in this color space) showing points similar to P which are the results of weighted averaging. The procedure is repeated for the other 11 half faces. The result is a number of weighted color points on all the faces of the color cube in color space 150 such as the RGB space. 2D surfaces of the RGB cube (color space 150) are converted to 3D surfaces in CIELAB color space (color space 160). What was a plane in RGB is now convex or concave in CIELAB. The transformation applied in CIELAB color space has an impact on the concavity of the surface of the gamut, and when the points are converted to the color space 150 the result in RGB is no longer a plane. The solution that can be adopted is to keep only a projection of the result on the original plane. As lines in color space 160 are curved in color space 150, it is possible that the lines in color space 150 go outside the color cube or gamut of color space 150 as shown schematically in FIG. 13c. In order to avoid moving some color points of the gamut surface inside it, or outside, the points can be forced to remain on the faces of the cube.

Accordingly, the procedures described above ensure that points on gamut edges remain on their corresponding edge and points on gamut faces remain on their corresponding gamut face; thus ensuring that the shape of the gamut and in the example of a display device, its contrast and saturation, is fully preserved. There can be a need to force points to remain on the surface:

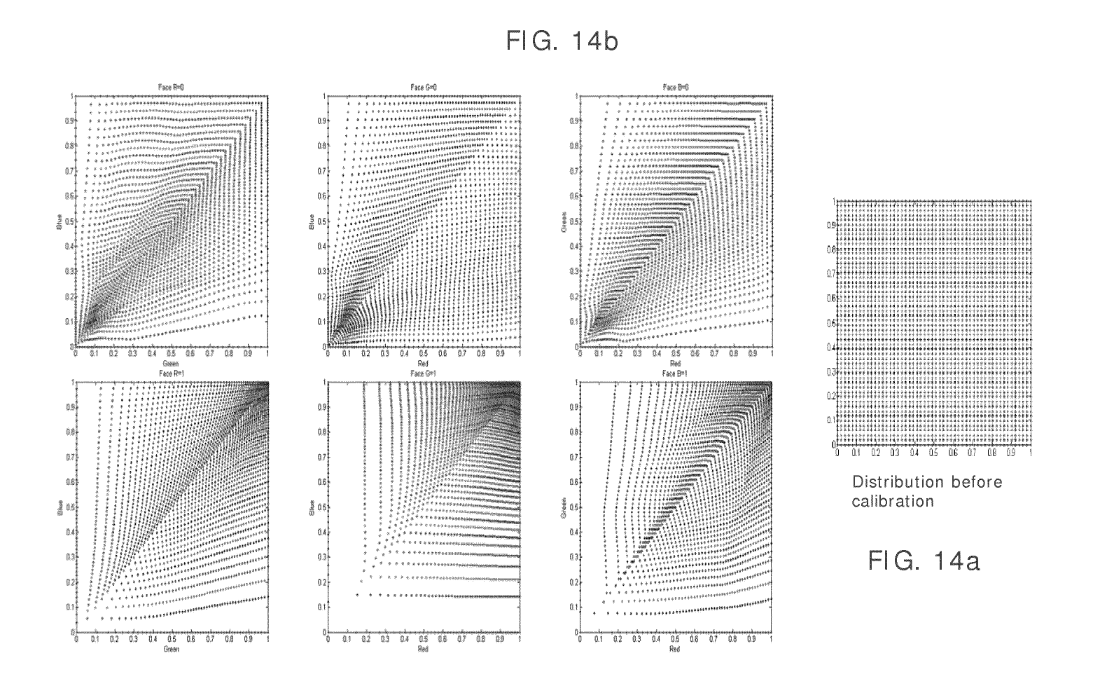

A Straight line in color space 2 such as L*a*b* is curved in color space 150 such as RGB.
Points of the faces could have been pulled in or forced out of the gamut.
Hence force one channel per face to be 0 or 1.
Face (Black; Green; Blue; Cyan) 4 R=0
Face (Red; Yellow; Magenta; White) 4 R=1
Face (Black; Red; Blue; Magenta) 4 G=0
Face (Green; Yellow; Cyan; White) 4 G=1
Face (Black; Red; Green; Yellow) 4 B=0
Face (Blue; Magenta; Cyan; White) 4 B=1
   FIG. 14a shows the uniform grid on a gamut face in color space 150. FIG. 14b shows the point distribution on the six faces of the gamut in color space 150 according to the results of the procedures above. These points have now improved perceptional linearity, e.g. are perceptually equidistant.

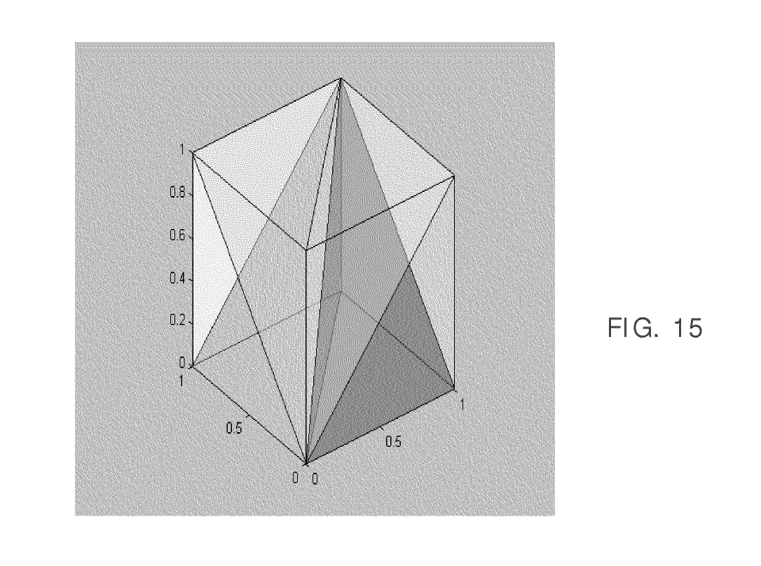

The next step is to populate the space inside the gamut volume (color cube) of color space 150. Suitable color points can be obtained by interpolating between the faces and the gray line of the gamut. To do so a volume filling geometrical structure can be used, e.g. a tetrahedron which is polyhedron with a polygon base and triangular faces connecting the base to a common point. In the case of a tetrahedron, the base is also a triangle. The six tetrahedrons that partition and fill the gamut volume in color space 150 are shown schematically in FIG. 15. Note that the six tetrahedrons have the gray line in common and each is bounded by two faces of the gamut in color space 150, and two planes passing through the gray line and lie within the gamut The GSDF calibrated gray line (i.e., points on it are equidistant in terms of JND) is used as one edge of six triangles that lie within the gamut. Such triangles along with those on the faces of the gamut complete the envelopes of the six tetrahedrons. The color points in these tetrahedrons are remapped such that color differences between the neighboring points are as equal as possible throughout each tetrahedron, while keeping the transition between tetrahedrons smooth.

Inside the color cube or gamut there is no need to force the triangles to remain in a plane after calibration, unless strict hue preservation is required. A population method is preferably chosen to guarantee that the gray behavior is not (substantially) altered and that the gamut of the visualization system remains (almost) intact. The gray line can be DICOM GSDF compliant, follow some gamma or have any desired behavior.

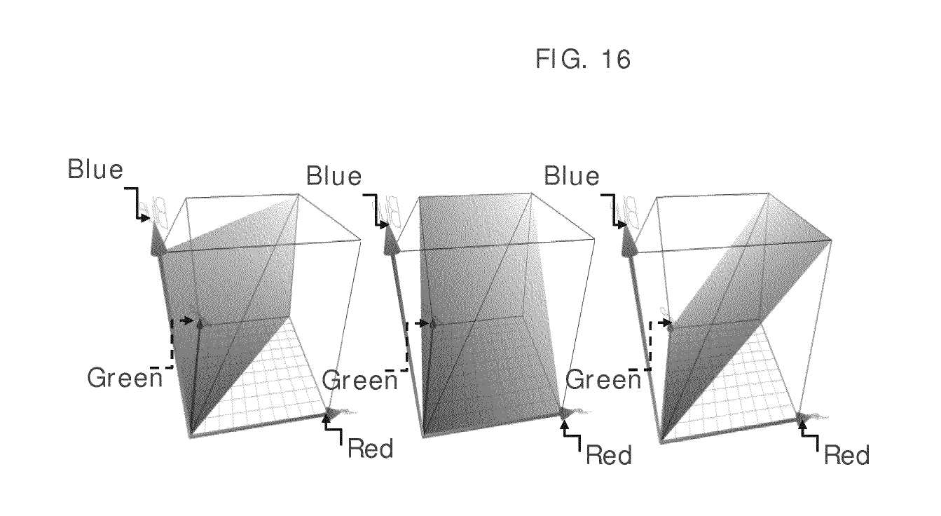

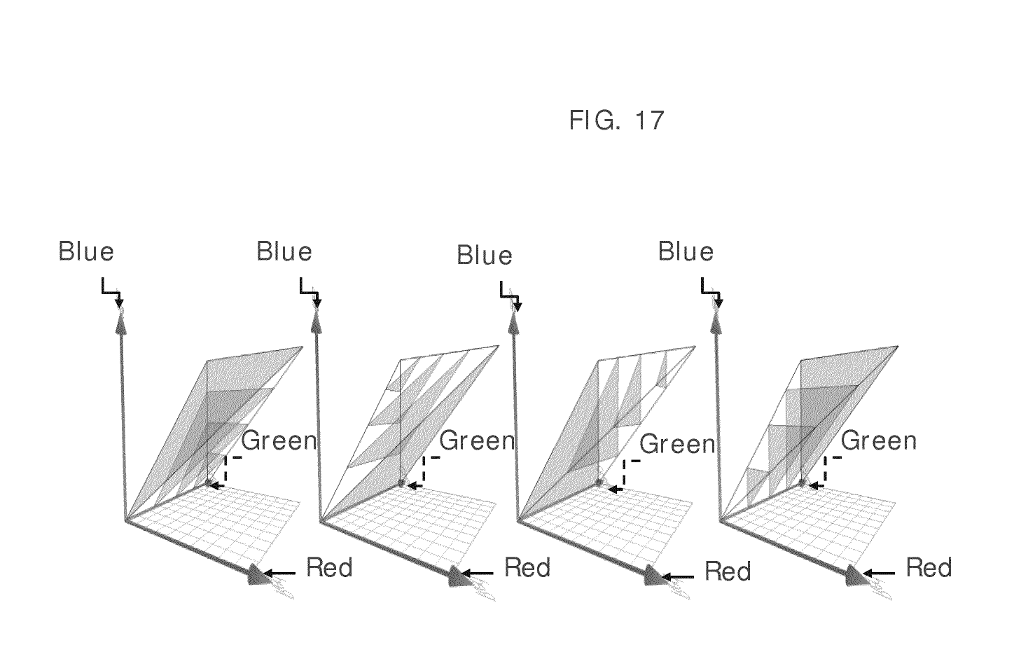

The tetrahedrons have triangular sides and each triangle is treated like the half-face triangles as described with respect to FIGS. 12 and 13. This generates points on the surface triangles of the tetrahedral. An example method of distributing the points and filling the bodies of the tetrahedrons is given below and shown schematically in FIGS. 16 and 17. The points inside the tetrahedron are merged from four candidates generated as shown schematically in FIGS. 16 and 17 by interpolation and averaging. The description below gives an example of how the tetrahedrons are filled and also discloses that the determined points are recorded in a suitable memory format e.g. a non-volatile look up table (LUT) memory as described above, for example.

Filling Tetrahedrons with Equidistant Color Points
This is a description of a method that can be used to fill the tetrahedrons based on the points of their faces that have been defined previously.

Below is given the example of a tetrahedron Black-Red-Yellow-White [(0, 0, 0)-(N−1, 0, 0)-(N−1, N−1, 0)-(N−1, N−1, N−1)]
N is the size of the 3D LUT.
O is the origin (i.e. the Black point of the RGB cube).

M_{RGB} is the point corresponding to input (R,G,B) (0, 0, 0) for Black, (N−1, N−1, N−1) for White.
LUT₁, LUT₂, LUT₃ and LUT₄ are temporary matrices used to store the results of the 4

```
for (i = 1; i < N; + + i)
  ////////// Direction 1: triangles normal to axis Black to Red => convergence to tip Black
  tip₁ = (i, i, 0) /* Changing from Black to Yellow with i */
  tip₂ = (i, 0, 0) /* Changing from Black to Red with i. */
  tip₃ = (i, i, i) /* Changing from Black to White with i. */
  Fill Triangle [tip₁ - tip₂ - tip₃] with 2D methods used for faces.
  Store [tip₁ - tip₂ - tip₃] in LUT₁
  ////////// Direction 2: triangles normal to axis Black to Blue => convergence to tip White
  tip₁ = (N − 1, i, i) /* Changing from Red to White with i. */
  tip₂ = (i, i, i) /* Changing from Black to White with i. */
  tip₃ = (N − 1, N − 1, i) /* Changing from Yellow to White with i. */
  Fill Triangle [tip₁ - tip₂ - tip₃] with 2D methods used for faces.
  Store [tip₁ - tip₂ - tip₃] in LUT₂
  ////////// Direction 3: triangles normal to third direction => convergence to tip Red
  tip₁ = (N − 1, N − i, 0) /* Changing from Yellow to Red with i. */
  tip₂ = (i, 0, 0) /* Changing from Black to Red with i. */
  tip₃ = (N − 1, N − i, N − i) /* Changing from White to Red with i. */
  Fill Triangle [tip₁ - tip₂ - tip₃] with 2D methods used for faces.
  Store [tip₁ - tip₂ - tip₃] in LUT₃
  ////////// Direction 4: triangles normal to Fourth direction => convergence to tip Yellow
  tip₁ = (N − 1, i, 0) /* Changing from Red to Yellow with i. */
  tip₂ = (i, i, 0) /* Changing from Black to Yellow with i. */
  tip₃ = (N − 1, N − 1, N − i) /* Changing from White to Yellow with i. */
  Fill Triangle [tip₁ - tip₂ - tip₃] with 2D methods used for faces.
  Store [tip₁ - tip₂ - tip₃] in LUT₄
```

////////// The loop above handles only one tetrahedron, but it can easily manage the 6 in parallel, and store everything in LUT₁, LUT₂, LUT₃ and LUT₄.

$$for ( i = 0 ; i < N ; ++ i )$$

$$for ( j = 0 ; j < N ; ++ j )$$

$$for ( j = 0 ; k < N ; ++ k )$$

$$LUT ( i , j , k ) = \frac{{LUT}_{1} ( i , j , k ) + {LUT}_{2} ( i , j , k ) + {LUT}_{3} ( i , j , k ) + {LUT}_{4} ( i , j , k )}{4}$$

This last equation shows that each point inside the tetrahedron can be interpolated from four others by averaging.

### Post Processing

The use of a color distance metric such as deltaE2000 to create color points having improved perceptional linearity, e.g. an equidistant distribution of points constrained by keeping the full gamut and GSDF gray are important features of embodiments of the present invention and for use with embodiments of the present invention, e.g. as described with reference to FIGS. 1 to 5. The interpolation techniques described above allow for smooth transition between color and gray behavior. While the interpolation techniques described above work better than known methods, it is only an example of a worked embodiment.

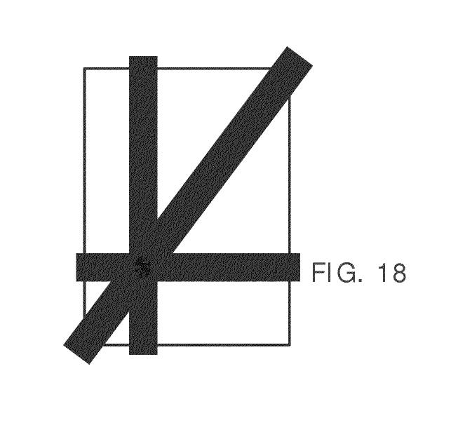

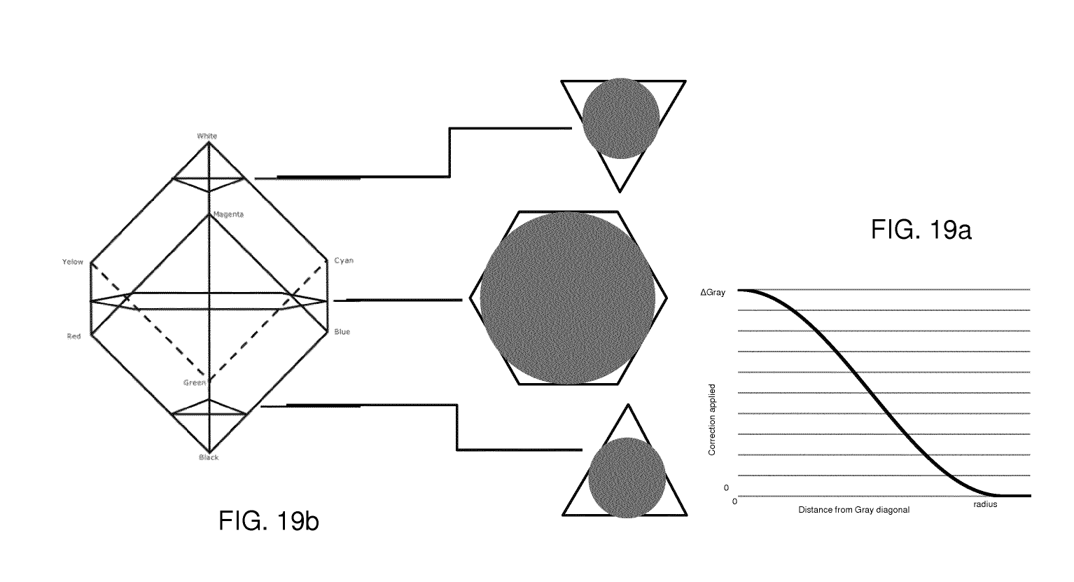

However, second-order discontinuities can still occur. In order to reduce the effect of discontinuities a blurring filter can be applied. For example, a 3D Gaussian blurring can be applied as shown schematically in FIG. 18. Such a filter can be a convolution filter with a quite a small edge kernel: for example a fifth or less of the LUT size. A Gaussian filter has the advantage of being separable, so the number of operations is proportional to the 1d-size of the LUT. The diameter of the filter is expressed in color points. A kernel of odd size can be selected to be symmetric around its central point: d=2r+1

The radius of the kernel is (rounded) for example one eleventh of the size of the LUT:

$$r = E ( 0.5 + \frac{n}{11} )$$

where n is the number of points per dimension of the 3D LUT (a 3D LUT of size n actually contains n³ points). Then, the i^{th} point of the kernel is defined as

$${k}_{i} = {e}^{( \frac{{( i - r )}^{2}}{2 d} )}$$

Finally the kernel is normalized to make the sum of all the coefficients equal to one:

$${k}_{i} = \frac{{k}_{i}}{{\sum }_{j}^{d} {k}_{j}} .$$

Other blurring filters can be used. The blurring filter will generally have an extent which is greater than the distance between two color points shown schematically in FIG. 19a. Management of the border effects is made to avoid moving the points of the surface within the LUT. Edges need not be filtered at all. However when the gray line is filtered, the DICOM calibration can be impaired. To avoid this, the gray points are returned to their correct positions to maintain DICOM GSDF for gray. To preserve the continuity of the colors, a blending is applied to color points in vicinity of gray on a plane orthogonal to gray. For each point of the diagonal, the blended area is defined as a 2D neighborhood in the plane orthogonal to the diagonal, and containing the considered gray levels. The area is the largest disk centered on gray that fits within the gamut in color space 150.

The points into this area are partially moved with the gray, and the amount of their movement depends on the ratio ‘distance to gray’/‘radius of the disk’. The higher is the ratio (i.e., the more saturated the color), the smaller is the movement. FIG. 19b shows cross sections of the color cube rotated to be orthogonal to gray. There is a hexagon around the middle of the cube and triangles close to black and white. FIG. 19a shows regular distribution of color points on a gamut cube and FIG. 14b shows the distribution of color points on 6 faces of the cube in an, or for use with any, embodiment of the present invention. FIG. 19b shows the correction applied as a function of the distance from the gray diagonal/the radius of the gray fields inside the hexagon and triangles. The procedure to be used after the blurring to bring back the gray points to their correct position and preserve the smoothness of the calibration is described below.

### Grayscale Correction and Blending

N is the size of the 3D LUT.
O is the origin (i.e. the Black point of the RGB cube).
Gᵢ is the exact position of the i^{th} gray point. /* Ordered from Black to White indexed from 0 to N−1*/
G′ᵢ is the actual position of the gray point after the blurring.
\vec{V}ₗ is the vector \vec{G′ₗGₗ}.

### for (R=0; R<N; ++R)

### for (G=0; G<N; ++G)

### for (B=0; B<N; ++B)

M is the point (R, G, B).

P is the projection of M on the Gray Diagonal.

op is the norm of vector \vec{OP}.

mp is the norm of vector \vec{MP}.

r is the radius of the largest disk centered on P, orthogonal to the Gray Diagonal and fitting into the RGB cube.

$$If ( m p < r ) \text{/} \text{*} If the points are within the disk defined by r \text{*} \text{/}$$

$$a = E ( \frac{op}{\sqrt{3}} ) \text{/} \text{*} a is an integer . \text{*} \text{/}$$

$$If ( a < N - 1 )$$

$$x = \frac{op}{\sqrt{3}} - a$$

\vec{T}=\vec{Vₐ}+x*(\vec{Vₐ₊₁}−\vec{Vₐ}) /* In case P is not equal to one of the known points of the diagonal (the Gᵢ), it has no vector \vec{V}ₗ associated. In this case, we perform a linear interpolation in between the vectors corresponding to the last Gᵢ before P and the first one after. */

else

\vec{T}=\vec{Vₐ}

$${M}^{′} = M + {T}^{->} * \frac{( 1 + cos ( \frac{m p}{r} * π ) )}{2} \text{/} \text{*}$$

This is the function taking care of moving the point proportionally to their distance to the diagonal. A graph representing this function is given below */

else /* If the points are outside this disk, they are not moved at all */

M′=M

M′ is the corrected point.
FIG. 20 is a flow chart of a calibration method 120 according to or for use with embodiments of the present invention, e.g. also for use with the embodiments described with reference to FIGS. 1 to 5. It can be applied on a region or regions or on the complete display. In step 121 a display device or system is characterized. This can involve measurements of the display device or system to determine the gamut of colors that can be displayed. An example of the gamut is a volume in a first color space such as the RGB color space. A transform is determined to transform any color point in the first color space to a second color space that is perceptually linear such as the CIELAB space. In step 122, color points on the primaries and other edges of the gamut volume in the first color space as well as constant hue diagonals of the gamut volume are spread to have improved perceptional linearity, e.g. equidistantly in a color distance metric such as deltaE2000. In step 122 gray points are spread to have improved perceptional linearity, e.g. equidistantly by means of a gray distance metric such as JND's. Preferably this is done obeying DICOM GSDF. In step 124 faces of the gamut volume in the first color space are populated with color points having improved perceptional linearity, e.g. equidistant points in a color distance metric such as deltaE2000. This is preferably done by interpolating from the edges and the diagonal of the gamut. In step 125 the volume of the gamut is populated with color points having improved perceptional linearity, e.g. equidistant points in a color distance metric such as deltaE2000 by interpolating between the faces of the gamut volume and the gray line. Optionally this can be done by constructing a set of volume filling geometrical figures such as a set of polyhydrons such as tetrahedrons. The internal faces of these figures are interpolated first. The interpolations may optionally made in the sRGB color space to boost saturation. In step 126 a smoothing filter can be applied. For example this could be a Gaussian low pass filter, e.g. a convolution filter. Gamut volume edge points and gray points are preferably forced not to move and points on the faces remain there. In this way the gamut volume is kept intact but some points are no longer spaced equidistantly. Despite this the set of calibrated color points as a whole still have improved perceptional linearity. Finally, in step 127, 3D LUT's are created and stored for example in a non-volatile memory of a display device, a controller for a display device or a display system. The 3D LUT provides the calibration transform that maps any point in the gamut volume in the first color space to a color point in a calibrated color space for use to display that color. This calibration provides one embodiment of a processing step of one or each determined region using a determined processing procedure to generate processed frame buffer content to be supplied to the display as the generated processed frame buffer content. This calibration also provides a transform in accordance with embodiments of the present invention. This can be applied on a region-by region basis or for the whole display.
Embodiments of the Present Invention when the Display Gamut is Known

Based on the above and the description of FIGS. 6 to 20 a method and system according to an embodiment of the present invention (also included in the embodiments described with reference to FIGS. 1 to 5) can be summarized as follows. It comprises the following steps:
1. Working on edges and diagonals of the faces of gamut in color space 150, e.g. an RGB cube. This step can involve setting points having improved perceptional linearity, e.g. at equidistant steps of a color distance metric such as deltaE2000 on all edges of a color cube (e.g. primaries, secondaries and ternaries; twelve total), and setting points having improved perceptional linearity, e.g. at equidistant steps of a grayscale distance metric such as JND equidistant on gray.
2. Working on faces of the gamut in color space 150, e.g. RGB Cube. Next, the color points are determined within each triangle made from the edges and/or gray, including the triangles within the color cube that make up the boundaries of a volume filling plurality of geometric structures such as tetrahedrons. Each color point within the triangle is interpolated in three different ways and its final location (in calibrated space) is calculated by weighted averaging of the three locations.
3. Working Inside of the gamut volume in color space 150, e.g. RGB cube. The grayscale diagonal such as DICOM GSDF is maintained and the tetrahedrons faces are populated with color points. Inside the tetrahedrons is populated with color points.
4. For example, the triangle interpolation technique above is repeated within each triangle of the tetrahedron. Hence, each point within each tetrahedron is interpolated in four different ways and its final location (in calibrated space) is calculated by weighted averaging of the four locations.
5. Post processing.

Some more smoothing can be applied as a post processing.

This calibration provides another embodiment of a processing step of one or each determined region using a determined processing procedure to generate processed frame buffer content to be supplied to the display as the generated processed frame buffer content. This calibration also provides a transform in accordance with embodiments of the present invention. This can be applied on a region-by region basis or for the whole display.
Embodiments of the present invention when the display gamut is not known
An embodiment of a system for visualizing medical color images or for use with a method according to or for use with embodiments of the present invention in a perceptual uniform color space can comprise the following components:
Internal color sensor
External color sensor
Visualization system with internal lookup tables and image processing modules whereby a method is provided to calculate lookup tables for the color calibration.
   This calibration provides one embodiment of a processing step of one or each determined region using a determined processing procedure to generate processed frame buffer content to be supplied to the display as the generated processed frame buffer content. This calibration also provides a transform in accordance with embodiments of the present invention. This can be applied on a region-by region basis or for the whole display.

Based on the above description with respect to FIGS. 6 to 21 (see below), the following steps can be executed to obtain the optimized perceptual uniform color space as is also included with in the embodiments described with reference to FIGS. 1 to 5.

The gamut of the visualization system is characterized using the internal and/or external color sensor. Depending on the required accuracy, more or less color points can be measured. The visualization system displays colors in N primary colors where N can be three for example (e.g. RGB) or four for example (CMYK) or more colors. Based on these measurements, N×1D LUT e.g. 3× or 4×1D LUT are determined that will be used to transform the gray diagonal of visualization system to conform to the desired behavior. The gray diagonal can be DICOM GSDF compliant or follow a gamma or any other transfer curve. In the following the invention will mainly be described with reference to a three primary color system but the present invention is not limited thereto.

Based on these measurements and taking into account the just defined 3×1D LUT, a 3D LUT is determined that will transform the remainder of the gamut of the visualization system or of a region to a perceptual linear color space. The metric used to judge the perceptual uniformity is preferably a color distance. A suitable distance is, for example deltaE2000, deltaE76 or any other suitable color metric. The method to determine the 3D LUT is preferably chosen to guarantee that the behavior of the gray diagonal is not altered (or not altered substantially) and that the gamut of the visualization system is not reduced (or not reduced significantly). This can be obtained by making use of a geometric structure. For example by defining 6 different tetrahedrons, which have the gray diagonal in common and are bounded by two planes of the input color space cube, e.g. RGB color cube and two planes through the gray diagonal. The six tetrahedrons together form a volume equal to the complete volume of the input color space cube e.g. RGB cube. The color points in these tetrahedrons are remapped such that color differences between the neighboring points are as equal as possible throughout the tetrahedron, while keeping the transition between tetrahedrons smooth. This is done by limiting the spreading of the points in 1D (edges of the tetrahedrons) then in 2D (faces of the tetrahedrons) and finally in 3D (triangles inside the tetrahedrons).

The determined 3×1D and 3D LUT are loaded in the internal lookup tables of the visualization system. From this moment onwards the visualization system for a region or for more than one region or for the whole display has a perceptually uniform color space and is optimized for viewing medical color images.

As an additional useful option which is an embodiment of the present invention, the system or method can be adapted so that the internal and/or external color sensor checks the perceptual uniformity of the color space of the visualization system on a regular and optionally automatic basis. When, due to the changes of the visualization system, it is not any longer perceptually uniform, the or any procedure described above can be repeated to maintain the perceptually uniformity of the system.

Embodiments of the Present Invention where the Calibration Transform is Integrated into a Display Device or Display System
FIG. 21 shows a more detailed embodiment of the display system of FIG. 2. This embodiment also discloses a display system for modifying content of a frame buffer prior to displaying the content of the frame buffer on a display. Any or all of the embodiments described with reference to FIGS. 1 to 5 can be implemented on the display system of FIG. 21. FIG. 21 shows a processing device 201 such as a personal computer (PC), a workstation, a tablet, a laptop, a PDA, a smartphone etc., a display controller 220 and a display 230. The processing device has a processor such as a microprocessor or an FPGA and memory such as RAM and/or non-volatile memory. The processing device 201 can be provided with an operating system 204 and a graphics driver 205. An application such as a viewing application 203 can run on the processing device 201 and can provide an image to the display controller 220 under the control of the operating system 204 and the driver 205 for display on the display device 230. The display device 230 can be any device which creates an image from image data such as a direct view screen, a rear projection screen, a computer screen, a projector screen or a printer. As shown in FIG. 21 for convenience and clarity the display device 230 displays the mage on display pixels 236 such as a screen (e.g. a fixed format display such as an LCD, OLED, plasma etc.) or projector and screen. Images may be input into the processing device 1 from any suitable input device such as from computer peripheral devices such as optical disks (CDROM, DVD-ROM, solid state memories, magnetic tapes, etc.) or via network communications interfaces (RS232, ETHERNET etc.) or bus interfaces such as IEEE-488-GPIB, ISA and EISA. Images may also be generated in processing device 201.

A modern display system comprises a display controller 220 such as medical display controller, e.g. provided with a programmable pipeline. A part of this programmable hardware pipeline can include an array of SIMD processors that are capable of executing short software programs in parallel. These programs are called “pixel shaders”, “fragment shaders”, or “kernels”, and take pixels as an input, and generate new pixels as an output. The image is stored in a frame buffer 218 in the display controller 220. A pixel shader 222 of display controller 220 processes the image and provides the new image to a further frame buffer 224. The new image is then provided with color information from a color Look-up-Table (non-volatile LUT memory) 226 (which can be in accordance with any of the embodiments of the present invention described with reference to FIGS. 1 to 5 or 6 to 20) and provided as a video output 228. The video output is stored in a frame buffer 232 of the display, optionally the image data further can be modified if necessary from a Look-up-Table (non-volatile LUT memory) 234 (which can be in accordance with any of the embodiments of the present invention described with reference to FIGS. 1 to 5 or 6 to 20) the display before being supplied to the pixels 36 of the display 30.

Embodiments making use of LUT's can be stored together with the 3D LUT in block 234 or block 226, either all 1D LUT's in block 234 or 226 or distributed over the two blocks. In accordance with embodiments of the present invention Look-up-Table (non-volatile LUT memory) 226 can be the main or only non-volatile LUT memory which stores the calibration transform of any of the embodiments of the present invention, i.e. described with reference to FIGS. 1 to 5 or 6 to 20.

In any of the embodiments of the present invention the color values of the input signal such as the RGB color components can be used to do a lookup in a 3D non-volatile LUT memory which can be in accordance with any of the embodiments of the present invention described with reference to FIGS. 1 to 5 or 6 to 20. Such a 3D non-volatile LUT memory in accordance with any of the embodiments of the present invention described with reference to FIGS. 1 to 5 or 6 to 20 can be implemented in a display (e.g. in or as non-volatile LUT memory 234) which could consist of three independent non-volatile LUT memories one for each color channel. In this case the display non-volatile LUT memory 234 preferably does not consist of three independent non-volatile LUT memories (one for each color channel), but it is a 3D non-volatile LUT memory where color points of an output color space such as RGB output triplets are stored for each (or a subset of) color points of an input color space such as RGB input triplets. In accordance with embodiments of the present invention Look-up-Table (non-volatile LUT memory) 234 can be the main or only non-volatile LUT memory which stores the calibration transform of any of the embodiments of the present invention. Alternatively the lookup in a 3D non-volatile LUT memory can also be integrated to the display controller 220, for example in a 3D non-volatile LUT memory 226 in accordance with any of the embodiments of the present invention. In accordance with embodiments of the present invention Look-up-Table (non-volatile LUT memory) 226 can be the main or only non-volatile LUT memory which stores the calibration transform of any of the embodiments of the present invention.

Alternatively, this 3D non-volatile LUT memory functionality can also be implemented as a post-processing texture non-volatile LUT memory in accordance with any of the embodiments of the present invention in a GPU, e.g. provided in display controller 220. For example, a 3D non-volatile LUT memory 227 in accordance with any of the embodiments of the present invention can be added as input to the Pixel shader 222. For example, a 3D non-volatile LUT memory 226 in accordance with any of the embodiments of the present invention can be the main or only non-volatile LUT memory which stores the calibration transform of any of the embodiments of the present invention.

In accordance with the present invention a non-volatile LUT memory such as LUT 226, 227 or 234 in accordance with any embodiment will be oversampled. For example the bit depth of the color points in the input color space can be less than the bit depth of the color points in the output space. Thus more colors can be reached in the output space compared with the input space while both can be RGB color spaces for example. However, it is included within the scope of the invention that optionally downsampling of the non-volatile LUT memory such as LUT 226, 227 or 234 can be applied to reduce the number of entries. In that case interpolation may be necessary to create color points in an output color space such an RGB output triplets corresponding to any arbitrary color points of an input color space such as RGB input triplets for which no output value was stored in the 3D non-volatile LUT memory such as LUT 226, 227 or 234. Any or all of these LUT's 226, 227 or 234 can be provided as a pluggable memory item. The display device 230 or the display system has means for inputting a color point of the native gamut to the non-volatile 3D LUT memory 226, 227 or 234 and for outputting a calibrated color point in accordance with the color transform. The non-volatile 3D LUT memory 226, 227 or 2 34 stores color points equidistant in three dimensions. The color points stored in the non-volatile 3D LUT memory are spaced by a color distance metric. The color points stored in the non-volatile 3D LUT memory can be spaced by a first distance metric in a first part of a color space, and a second distance metric in another part of the color space.

Also in embodiments described with reference to FIGS. 6 to 20, the display can include a physical sensor configured to measure light emitting from a measurement area of the display. In order to calibrate the display as described with reference to FIGS. 6 to 20 using the sensor for regions generated by different applications, the area under the sensor is iterated to display different regions. That is, the display system varies in time the region of the content of the frame buffer displayed in the measurement area of the display. This automatic translation of the region displayed under the sensor allows the static sensor to measure the characteristics of each displayed region. In this way, the physical sensor measures and records properties of light emitting from each of the determined regions. Using this method, calibration and QA reports may be generated that include information for each application responsible for content rendered in the content of any frame buffer. One method for driving the calibration and QA is to post-process measurements recorded by the sensor with the processing that is applied to each measured region. An alternative method for driving the calibration and QA is to pre-process each rendered region measured by the sensor.

In order to stop the calibration and QA checks from becoming very slow (because of the large number of measurements needed to support all of the different regions), a system of caching measurements may be utilized. For the different display settings that need to be calibrated/checked, there may be a number of measurements in common. It is not efficient to repeat all these measurements for each display as setting since this would take a lot of time and significantly reduce speed of calibration and QA as a result. Instead, what is done is that a “cache” will be kept of measurements that have been performed. This cache contains a timestamp of the measurement, the specific value (RGB value) that was being measured, together with boundary conditions such as backlight setting, temperature, ambient light level, etc.). If a new measurement needs to be performed, the cache is inspected to determine if new measurement (or a sufficiently similar measurement) has been performed recently (e.g., within one day, one week, or one month). If such a sufficiently similar measurement is found, then the measurement will not be performed again, but the cached result will instead be used. If no sufficiently similar measurement is found in the cache (e.g., because the boundary conditions were too different or because there is a sufficiently similar measurement in cache but that is too old), then the physical measurement will be performed and the results will be placed in cache.

### Implementation

Methods according to embodiments of the present invention and systems according to the present invention which are adapted for processing of an image in a region, in regions or for the whole display and for, for example, generating a transform according to any embodiment of the present invention such as a calibration transform, can be implemented on a computer system that is specially adapted to implement methods of the present invention. The computer system includes a computer with a processor and memory and preferably a display. The memory stores machine-readable instructions (software) which, when executed by the processor cause the processor to perform the described methods. The computer may include a video display terminal a data input means such as a keyboard, and a graphic user interface indicating means such as a mouse or a touch screen. The computer may be a work station or a personal computer or a laptop, for example.

The computer typically includes a Central Processing Unit (“CPU”), such as a conventional microprocessor of which a Pentium processor supplied by Intel Corp. USA is only an example, and a number of other units interconnected via bus system. The bus system may be any suitable bus system. The computer includes at least one memory. Memory may include any of a variety of data storage devices known to the skilled person such as random-access memory (“RAM”), read-only memory (“ROM”), and non-volatile read/write memory such as a hard disc as known to the skilled person. For example, the computer may further include random-access memory (“RAM”), read-only memory (“ROM”), as well as a display adapter for connecting the system bus to a video display terminal, and an optional input/output (I/O) adapter for connecting peripheral devices (e.g., disk and tape drives) to the system bus. The video display terminal can be the visual output of computer, and can be any suitable display device such as a CRT-based video display well-known in the art of computer hardware. However, with a desktop computer, a portable or a notebook-based computer, the video display terminal can be replaced with a LCD-based or a gas plasma-based flat panel display. The computer further includes a user interface adapter for connecting a keyboard, mouse, and optional speaker.

The computer can also include a graphical user interface that resides within machine-readable media to direct the operation of the computer. Any suitable machine-readable media may retain the graphical user interface, such as a random access memory (RAM), a read-only memory (ROM), a magnetic diskette, magnetic tape, or optical disk (the last three being located in disk and tape drives). Any suitable operating system and associated graphical user interface (e.g., Microsoft Windows, Linux) may direct CPU. In addition, computer includes a control program that resides within computer memory storage. Control program contains instructions that when executed on CPU allow the computer to carry out the operations described with respect to any of the methods of the present invention.

Those skilled in the art will appreciate that other peripheral devices such as optical disk media, audio adapters, or chip programming devices, such as PAL or EPROM programming devices well-known in the art of computer hardware, and the like may be utilized in addition to or in place of the hardware already described.

The computer program product for carrying out the method of the present invention can reside in any suitable memory and the present invention applies equally regardless of the particular type of signal bearing media used to actually store the computer program product. Examples of computer readable signal bearing media include: recordable type media such as floppy disks and CD ROMs, solid state memories, tape storage devices, magnetic disks.

The software may include code which when executed on a processing engine causes a color calibration method for use with a display device to be executed. The software may include code which when executed on a processing engine causes expression of a set of color points defining a color gamut in a first color space. The software may include code which when executed on a processing engine causes mapping of said set of color points from the first color space to a second color space.

The software may include code which when executed on a processing engine causes redistributing the mapped set of points in the second color space wherein the redistributed set has improved perceptional linearity while substantially preserving the color gamut of the set of points. The software may include code which when executed on a processing engine causes mapping the redistributed set of points from the second color space to a third color space. and storing the mapped linearized set of points in the non-volatile memory for the display device as a calibration transform.

The software may include code which when executed on a processing engine causes redistributing the mapped set of points in the second color space by linearizing the mapped set of points in the second color space by making the color points in the second color space equidistant throughout the color space. The third color space is the same as the first color space. The software may include code which when executed on a processing engine allows receipt of measurements of the set of color points in the first color space.

The software may include code which when executed on a processing engine causes the improved perceptional linearity to be obtained by: Partitioning the color gamut in the first color space using polyhedrons such as tetrahedrons;

Redistributing the set of color points on the edges of each polyhedron to obtain improved perceptual linearity on the edges of each polyhedron;
Redistributing the set of color points on the faces of each polyhedron to obtain improved perceptual linearity on the faces by replacing each such color point by an interpolated value obtained based on the redistributed color points surrounding points on edges of the polyhedron that form the boundaries of that face of the polyhedron;
Redistributing the set of color points inside each polyhedron to obtain improved perceptual linearity by replacing each such color point by an interpolated value obtained based on the redistributed points surrounding faces of the polyhedron containing the inside color point.

The software may include code which when executed on a processing engine causes the improved perceptional linearity to be obtained by:

Partitioning the color gamut in the first color space using polyhedrons such as tetrahedrons;
Redistributing the set of color points on the edges of each polyhedron to obtain improved perceptual linearity on the edges of each polyhedron; Redistributing the set of color points on the faces of each polyhedron to obtain improved linearity of the Euclidean distances between color points on the faces by replacing each such color point by an interpolated value obtained based on the redistributed points surrounding points on edges of the polyhedron that form the boundaries of that face of the polyhedron;
Redistributing the set of color points inside each polyhedron to obtain improved linearity of the Euclidean distances between color points inside each polyhedron by replacing each such color point by an interpolated value obtained based on the redistributed surrounding faces of the polyhedron containing the inside color point.

The software may include code which when executed on a processing engine causes the color point linearizing procedure to make color points that are spaced by a color distance metric of equidistance in the second color space.

The software may include code which when executed on a processing engine causes a first distance metric to be used in a first part of the second color space, and a second distance metric to be used in another part of the second color space. The second part of the second color space can primarily contain the neutral gray part of the second color space and the first part of the second color space can primarily exclude the neutral gray part of the second color space.

The software may include code which when executed on a processing engine causes the point linearizing procedure to comprise setting gray points in the second color space equidistant in terms of a second distance metric.

The software may include code which when executed on a processing engine causes DICOM GSDF compliance for gray to be ensured.

The software may include code which when executed on a processing engine causes applying of a smoothing filter to reduce discontinuities in the border areas between the first part of the second color space and the second part of the second color space.

The software may be stored on a suitable non-transitory signal storage means such as optical disk media, solid state memory devices, magnetic disks or tapes or similar.

As will be understood by one of ordinary skill in the art, any processor used in the system shown in FIG. 21 may have various implementations. For example, the processor may include any suitable device, such as a programmable circuit, integrated circuit, memory and I/O circuits, an application specific integrated circuit, microcontroller, complex programmable logic device, other programmable circuits, or the like. The processor may also include a non-transitory computer readable medium, such as random access memory (RAM), a read-only memory (ROM), an erasable programmable read-only memory (EPROM or Flash memory), or any other suitable medium.

Instructions for performing the method described below may be stored in the non-transitory computer readable medium and executed by the processor. The processor may be communicatively coupled to the computer readable medium and the graphics processor through a system bus, mother board, or using any other suitable structure known in the art.

As will be understood by one of ordinary skill in the art, the display settings and properties defining the plurality of regions may be stored in the non-transitory computer readable medium.

The present disclosure is not limited to a specific number of displays. Rather, the present disclosure may be applied to several virtual displays, e.g., implemented within the same display system.

1-62. (canceled)

63. A display system for modifying content of a frame buffer prior to displaying the content of the frame buffer on a display, the display system configured to:
receive the content of the frame buffer;
determine a plurality of regions present in the content of the frame buffer which represent content provided by at least one process;
for each determined region, determine desired display settings for the content of the frame buffer located in the determined region;
process the received content of the frame buffer to generate processed frame buffer content, the processing comprising:
for each determined region present in the content of the frame buffer:
determining a processing procedure to modify the content of the determined region such that, when visualized on the display, properties of the content of the determined region coincide with the desired display settings for the determined region;
processing the determined region using the determined processing procedure to generate processed frame buffer content;
supply the generated processed frame buffer content to the display.

64. A method for modifying content of a frame buffer prior to displaying the content of the frame buffer on a display, the method comprising:
receiving the content of the frame buffer;
determining a plurality of regions present in the content of the frame buffer which represent content provided by at least one process;
for each determined region, determining desired display settings for the content of the frame buffer located in the determined region;
generating processed frame buffer content by processing the received content of the frame buffer, the processing comprising:
for each determined region present in the content of the frame buffer:
determining a processing procedure to modify the content of the determined region such that, when visualized on the display, properties of the content of the determined region coincide with the desired display settings for the determined region;
processing the determined region using the determined processing procedure to generate processed frame buffer content;
supplying the generated processed frame buffer content to a display.

65. The method of claim 64, wherein:
determining the processing procedure comprises:
determining a type of processing to perform on the content of the frame buffer; and
determining a data element that, when used to process the content of the frame buffer, performs the determined the type of processing.

66. The method according to claim 64, wherein:
determining the plurality of regions of the frame buffer comprises a user identifying a region and, for each identified region, the user selects desired display settings.

67. The method according to claim 64, wherein the desired display settings for a particular determined region are determined based on characteristics of the particular determined region.

68. The method of claim 67, wherein the characteristics of the particular region include at least one of:
whether pixels in the particular region are primarily grayscale, primarily color, or a mix of grayscale and color; or
a name of the process controlling rendering of the particular region.

69. The method according to claim 64, wherein the processing procedure comprises at least one of color processing or luminance processing.

70. The method according to claim 64, wherein:
the determined data element for processing comprises a first transformation element; and
processing a particular region comprises using the first transformation element, wherein the first transformation element is a three-dimensional (3D) LUT and the content of the 3D LUT is computed from the desired display settings and data stored in an ICC profile for the display.

71. The method of claim 70, wherein:
the determined data element for processing further comprising a second transformation element; and
processing the particular region using the first transformation element comprises:
processing the particular region using the second transformation element to generate a resultant region; and
processing the resultant region using the first transformation element, wherein the second transformation element is three one-dimensional (1D) lookup tables (LUTs) and the three 1D LUTs are computed from a mathematical model of the desired display settings.

72. The method according to claim 64 further comprising a color calibration method comprising the steps:
expressing a set of color points defining a color gamut in a first color space;
mapping said set of color points from the first color space to a second color space;
redistributing the mapped set of points in the second color space wherein the redistributed set has improved perceptional linearity while substantially preserving the color gamut of the set of points,
mapping the redistributed set of points from the second color space to a third color space, and
storing the mapped linearized set of points in the non-volatile memory for the display device as a calibration transform.

73. The method of claim 72 wherein redistributing the mapped set of points in the second color space comprises linearizing the mapped set of points in the second color space by making the color points in the second color space equidistant throughout the color space.

74. The method of claim 72, wherein the third color space is the same as the first color space.

75. The method of claim 72, further comprising the step:
measuring the set of color points in the first color space.

76. The method of claim 72, wherein the improved perceptional linearity is obtained by:
partitioning the color gamut in the first color space using polyhedrons such as tetrahedrons;
redistributing the set of color points on the edges of each polyhedron to obtain improved perceptual linearity on the edges of each polyhedron;
redistributing the set of color points on the faces of each polyhedron to obtain improved perceptual linearity on the faces by replacing each such color point by an interpolated value obtained based on the redistributed color points surrounding points on edges of the polyhedron that form the boundaries of that face of the polyhedron;
redistributing the set of color points inside each polyhedron to obtain improved perceptual linearity by replacing each such color point by an interpolated value obtained based on the redistributed points surrounding faces of the polyhedron containing the inside color point.

77. The method of claim 72, wherein the improved perceptional linearity is obtained by:
partitioning the color gamut in the first color space using polyhedrons such as tetrahedrons;
redistributing the set of color points on the edges of each polyhedron to obtain improved perceptual linearity on the edges of each polyhedron;
redistributing the set of color points on the faces of each polyhedron to obtain improved linearity of the Euclidean distances between color points on the faces by replacing each such color point by an interpolated value obtained based on the redistributed points surrounding points on edges of the polyhedron that form the boundaries of that face of the polyhedron;
redistributing the set of color points inside each polyhedron to obtain improved linearity of the Euclidean distances between color points inside each polyhedron by replacing each such color point by an interpolated value obtained based on the redistributed surrounding faces of the polyhedron containing the inside color point.

78. The method of claim 72, wherein the color point linearizing procedure involves making color points that are spaced by a color distance metric of equidistance in the second color space.

79. The method of claim 78, wherein a first distance metric is used in a first part of the second color space, and a second distance metric is used in another part of the second color space.

80. The method of claim 79, wherein the second part of the second color space primarily contains the neutral gray part of the second color space and where the first part of the second color space primarily excludes the neutral gray part of the second color space.

81. The method of claim 72, wherein the point linearizing procedure further comprises setting gray points in the second color space equidistant in terms of a second distance metric.

82. The method of claim 72, further comprising ensuring DICOM GSDF compliance for gray.

83. The method according to claim 72, further comprising applying a smoothing filter to reduce discontinuities in the border areas between the first part of the second color space and the second part of the second color space.

84. The method according to claim 72, further comprising:
recording measurements of light emitted from a measurement area of the display using a physical sensor;
varying in time the region of the content of the frame buffer displayed in the measurement area of the display; and
recording properties of light emitting from each of the determined regions.

85. A non-transient storage medium storing a computer program for executing the method of claim 64, when executed by a processor.

86. A controller for a display system for modifying content of a frame buffer prior to displaying the content of the frame buffer on a display, the controller being configured to:
receive the content of the frame buffer;
determine a plurality of regions present in the content of the frame buffer which represent content provided by at least one process;
for each determined region, determine desired display settings for the content of the frame buffer located in the determined region;
process the received content of the frame buffer to generate processed frame buffer content, the processing comprising:
for each determined region present in the content of the frame buffer:
determining a processing procedure to modify the content of the determined region such that, when visualized on the display, properties of the content of the determined region coincide with the desired display settings for the determined region;
processing the determined region using the determined processing procedure to generate processed frame buffer content;
supply the generated processed frame buffer content to the display.
